(19) United States
(12) Patent Application Publication
(10) Pub. No.: US 2025/0199469 A1
(43) Pub. Date: Jun. 19, 2025

(54) PROCESSING CARTRIDGE

(71) Applicant: Zhuhai Ninestar Information Technology Co. , Ltd, Zhuhai (CN)

(72) Inventors: Qin LUO, Zhuhai (CN); Yinghao LI, Zhuhai (CN); Hailong MA, Zhuhai (CN); Jialu YU, Zhuhai (CN); Qingrui ZHU, Zhuhai (CN); Qin DAI, Zhuhai (CN)

(21) Appl. No.: 19/013,587

(22) Filed: Jan. 8, 2025

Related U.S. Application Data
(63) Continuation of application No. PCT/CN2023/120106, filed on Sep. 20, 2023.

(30) Foreign Application Priority Data
Sep. 21, 2022 (CN) 202222518779.9
Sep. 29, 2022 (CN) 202222603855.6
Nov. 9, 2022 (CN) 202222982364.7
Nov. 10, 2022 (CN) 202222996944.1
Nov. 18, 2022 (CN) 202223091718.5
Nov. 28, 2022 (CN) 202223179257.7
Nov. 30, 2022 (CN) 202223214295.1
Dec. 6, 2022 (CN) 202223282309.3
Dec. 28, 2022 (CN) 202223593610.6

(51) Int. Cl. G03G 21/18

(52) U.S. Cl. CPC G03G 21/1864; G03G 21/1814; G03G 21/1821; G03G 21/186

(57) ABSTRACT

A processing cartridge includes a photosensitive unit, including: a photosensitive drum and a photosensitive frame; a developing unit, including a developing roller and a developing frame, where the developing unit can move, relative to the photosensitive unit, between a contact position where the developing roller contacts the photosensitive drum and a separated position where the developing roller is separated from the photosensitive drum; a developing coupling, for receiving a rotational driving force and being disposed at one end of a length direction of the processing cartridge; and an elastic member, disposed between the developing unit and the photosensitive unit.

### CROSS-REFERENCE TO RELATED APPLICATION

This application is a continuation of International Application No. PCT/CN2023/120106, filed Sep. 20, 2023, which claims priority of Chinese Patent Application No. 202222518779.9 filed on Sep. 21, 2022, Chinese Patent Application No. 202222603855.6 filed on Sep. 29, 2022, Chinese Patent Application No. 202222996944.1 filed on Nov. 10, 2022, Chinese Patent Application No. 202222982364.7 filed on Nov. 9, 2022, Chinese Patent Application No. 202223091718.5 filed on Nov. 18, 2022, Chinese Patent Application No. 202223179257.7 filed on Nov. 28, 2022, Chinese Patent Application No. 202223214295.1 filed on Nov. 30, 2022, Chinese Patent Application No. 202223282309.3 filed on Dec. 6, 2022, and Chinese Patent Application No. 202223593610.6 filed on July Dec. 28, 2022, the entire content of each of which is hereby incorporated by reference.

### TECHNICAL FIELD

The present application relates to the technical field of image-forming devices, in particular to a processing cartridge.

### BACKGROUND

Image-forming devices form an image on a recording material (such as paper) using an electrophotographic imaging process. Examples of image-forming devices include electrophotographic copiers, electrophotographic printers, fax machines, word processors, etc. The cartridge of an image-forming device includes at least one of an electrophotographic photosensitive drum as a photosensitive member and a developing member (such as a developing roller) that can act on the drum, and the photosensitive member and the developing member may also be integrally constructed as a cartridge (which may be referred to as a processing cartridge) that can be detachably mounted on the image-forming device.

In Chinese Patent Application No. CN113574468A, the processing cartridge adopts a dual-drive structure, where a photosensitive driving member and a developing driving member receive the drive from a photosensitive driving mechanism and a developing driving mechanism of the image-forming device respectively, thereby driving a photosensitive drum and a developing roller to rotate respectively. In addition, a force accommodating member cooperates with a separation control mechanism of the image-forming device to implement contact or separation between the photosensitive drum and the developing roller. When the force accommodating member receives a separating force of the separation control mechanism of the image-forming device, the photosensitive drum and the developing roller in the processing cartridge are separated (referred to as “drum roller separation”), and the photosensitive drum and the developing roller are kept in a separated state by a movable retaining member. When the accommodating member receives a contacting force of the separation control mechanism of the image-forming device, the retaining member does not maintain, and the photosensitive drum and the developing roller in the processing cartridge are in contact (referred to as drum roller contact).

In Chinese Patent Application No. CN113574468A, the structure and operation mode of the force accommodating member and the retaining member are complex, resulting in high production costs. The retaining member must operate in coordination with the components of the image-forming device. Since the retaining member has a small structure and insufficient strength, it is easily damaged during long-term operation, shortening the service life of the processing cartridge.

### SUMMARY

One aspect of the present disclosure provides a processing cartridge, including a photosensitive unit, including a photosensitive drum and a photosensitive frame; a developing unit, including a developing roller and a developing frame, where the developing unit is capable of moving, relative to the photosensitive unit, between a position where the developing roller contacts the photosensitive drum and a position where the developing roller is separated from the photosensitive drum; a developing coupling, for receiving a rotational driving force and being disposed at one end of a length direction of the processing cartridge; and an elastic member, disposed between the developing unit and the photosensitive unit, where, when the developing coupling does not receive the rotational driving force to rotate, under an action of an elastic force, the developing unit is maintained at a separated position, and the developing roller is kept separated from the photosensitive drum; and when the developing coupling receives the rotational driving force to rotate, a rotational torque exerts a force on the developing unit to move the developing unit from the separated position to a contact position, so that the developing roller contacts the photosensitive drum.

In some embodiments, when the developing coupling does not receive the rotational driving force to rotate, the elastic force of the elastic member acts on the developing unit to make a lower end of the developing unit away from the photosensitive unit, so that the developing roller is kept separated from the photosensitive drum.

In some embodiments, when the developing coupling receives the rotational driving force to rotate, the force exerted by the rotational torque on the developing unit is greater than the force of the elastic member on the developing unit, and the lower end of the developing unit moves toward a direction close to the photosensitive unit, so that the developing unit moves from the separated position to the contact position.

In some embodiments, the elastic member is a tension spring; and when the developing coupling does not receive the rotational driving force to rotate, a force of the tension spring acts on the developing unit so that the lower end of the developing unit has a tendency to rotate around a rotation center away from the photosensitive unit.

In some embodiments, the processing cartridge further includes a driving side end cover and a developing box cover, where the driving side end cover is located at one end of the photosensitive frame, the developing box cover is located at one end of the developing frame, and the driving side end cover covers an outside of the developing box cover; and the elastic member is located at one end of the length direction of the processing cartridge, one end of the elastic member is sleeved on the driving side end cover, and another end of the elastic member is sleeved on the developing box cover.

In some embodiments, the processing cartridge further includes a developing roller gear and a photosensitive drum gear, where the developing roller gear is sleeved on one end of the developing roller, and the photosensitive drum gear is disposed at one end of the photosensitive drum; and the developing coupling receives the rotational driving force and transmits the rotational driving force to the developing roller gear, and then the developing roller gear transmits the rotational driving force to the photosensitive drum gear to drive the photosensitive drum to rotate.

Another aspect of the disclosure provides a processing cartridge, detachably mounted in an image forming device, and including: a photosensitive unit, including a photosensitive drum and a photosensitive frame; a developing unit, including a developing roller and a developing frame, where the developing unit is capable of moving, relative to the photosensitive unit, between a position where the developing roller contacts the photosensitive drum and a position where the developing roller is separated from the photosensitive drum; a developing coupling, for receiving a rotational driving force and being disposed at one end of a length direction of the processing cartridge; and an elastic member, disposed between the developing unit and the photosensitive unit, where, when the processing cartridge stops developing in the image forming device, an elastic force of the elastic member keeps the developing unit in a separated position; and when the developing coupling receives the rotational driving force from the image forming device and starts to rotate, a rotational torque exerts a force on the developing unit to move the developing unit from the separated position to a contact position, so that the developing roller contacts the photosensitive drum.

In some embodiments, when the developing unit stops developing, the elastic force of the elastic member acts on the developing unit to move a lower end of the developing unit away from the photosensitive unit, so that the developing roller and the photosensitive drum remain separated; and when the developing coupling receives the rotational driving force from the image forming device and starts to rotate, the force exerted by the rotational torque on the developing unit is greater than the elastic force exerted by the elastic member on the developing unit, and the lower end of the developing unit moves toward the photosensitive unit, so that the developing unit moves from the separated position to the contact position.

Another aspect of the disclosure provides a processing cartridge, including: a photosensitive unit having a photosensitive drum; a developing unit having a developing roller, where the developing unit is capable of moving, relative to the photosensitive unit, between a contact position where the developing roller contacts the photosensitive drum and a separated position where the developing roller separates from the photosensitive drum; a developing coupling, for receiving a rotational driving force and being disposed at a driving end of the processing cartridge; and an elastic member connected to the photosensitive unit and the developing unit, where, when the developing coupling stops rotating, under an action of the elastic member, the developing unit is in the separated position, and the developing roller remains separated from the photosensitive drum; and when the developing coupling receives power to rotate, a rotational force generated by a rotation of the developing coupling is greater than an elastic force of the elastic member, so that the developing unit moves from the separated position to the contact position, and the developing roller moves toward the photosensitive drum, and where, a delay mechanism is also included, and the delay mechanism delays the time for the developing unit to move from the separated position to the contact position, so that the developing roller delays a contact with the photosensitive drum.

In some embodiments, when the developing coupling stops rotating, the developing unit moves from the contact position to the separated position without delay, and the developing roller is quickly separated from the photosensitive drum.

In some embodiments, the processing cartridge further includes connecting teeth, where: the connecting teeth are located at one end of the developing unit; the delay mechanism has a delay gear; and when the developing coupling receives the power to rotate, when the developing unit moves from the separated position to the contact position, the developing unit drives the connecting teeth to rotate and transmits the rotational force to the delay gear.

Another aspect of the disclosure provides a processing cartridge, including: a photosensitive unit, including a photosensitive drum and a photosensitive frame; a developing unit, including a developing roller and a developing frame, where the developing unit is capable of moving, relative to the photosensitive unit, between a position where the developing roller contacts the photosensitive drum and a position where the developing roller separates from the photosensitive drum; a developing coupling, for receiving a rotational driving force and being disposed at one end of a length direction of the processing cartridge; an elastic member, connected to the developing unit and the photosensitive unit; a transmission member, rotatably arranged at one end of the developing unit, the transmission member capable of being driven to rotate by the developing coupling; and a rotating member, rotatably arranged at one end of the photosensitive unit, the rotating member capable of being driven to rotate by the transmission member, where, in a process of a lower end of the developing unit moving toward a lower end of the photosensitive unit, when the transmission member driven to rotate by the developing coupling drives the rotating member to rotate, the developing roller and the photosensitive drum are not yet in contact; and when the rotating member is unable to be driven to rotate by the transmission member, the developing unit moves to a position where the developing roller contacts the photosensitive drum, so that the developing roller contacts the photosensitive drum.

In some embodiments, the transmission member drives the rotating member to rotate by meshing with a gear of the rotating member.

In some embodiments, a circumferential surface of the rotating member is provided with a gear portion, and the gear portion is provided with a section of teeth.

In some embodiments, the transmission member and/or a surface of the transmission member has friction, and the transmission member drives the rotating member to rotate by the friction.

In some embodiments, the processing cartridge further includes a driving side bearing, where the driving side bearing is disposed at one end of a length direction of the developing unit, the transmission member is rotatably supported on the driving side bearing, and in a height direction of the processing cartridge, the transmission member is arranged close to the lower end of the developing unit.

In some embodiments, the processing cartridge further includes a photosensitive coupling, where the photosensitive coupling is disposed at one end of a length direction of the photosensitive drum, and the rotating member is sleeved on the photosensitive coupling; and when the developing coupling does not drive the transmission member to rotate, and the transmission member does not drive the rotating member to rotate, the photosensitive coupling is capable of driving the rotating member to rotate under an action of a friction between the photosensitive coupling and the rotating member.

Another aspect of the disclosure provides a processing cartridge, including: a photosensitive unit, including a photosensitive drum and a photosensitive frame; a developing unit, including a developing roller and a developing frame, where the developing unit is capable of moving, relative to the photosensitive unit, between a position where the developing roller contacts the photosensitive drum and a position where the developing roller separates from the photosensitive drum; a developing coupling, for receiving a rotational driving force and being disposed at one end of a length direction of the processing cartridge; an elastic member, connected to the developing unit and the photosensitive unit; a transmission member, rotatably arranged at one end of the developing unit, the transmission member capable of being driven to rotate by the developing coupling; and a rotating member, rotatably arranged at one end of the photosensitive unit, the rotating member capable of being driven to rotate by the transmitting member, where, before the developing coupling receives the rotational driving force, under an action of an elastic force, the developing unit is maintained at a position where the developing roller is separated from the photosensitive drum, and the developing roller is kept separated from the photosensitive drum, and where, when the developing coupling receives the rotational driving force to rotate, under an action of a driving force torque, a lower end of the developing unit moves toward a lower end of the photosensitive unit; when the developing coupling drives the transmission member to rotate, and the transmission member drives the rotating member to rotate, the developing roller and the photosensitive drum are not yet in contact; and when the rotating member is unable to be driven to rotate by the transmission member, the developing unit moves to a position where the developing roller contacts the photosensitive drum, so that the developing roller contacts the photosensitive drum.

In some embodiments, the transmission member drives the rotating member to rotate by meshing with a gear of the rotating member, and a circumferential surface of the rotating member is provided with a gear portion, and the gear portion is provided with a section of teeth.

In some embodiments, the transmission member and/or a surface of the transmission member has friction, and the transmission member drives the rotating member to rotate by the friction.

In some embodiments, the processing cartridge further includes a photosensitive coupling, where the photosensitive coupling is disposed at one end of a length direction of the photosensitive drum, and the rotating member is sleeved on the photosensitive coupling; and when the developing coupling does not drive the transmission member to rotate, and the transmission member does not drive the rotating member to rotate, the photosensitive coupling is capable of driving the rotating member to rotate under an action of a friction between the photosensitive coupling and the rotating member.

Other aspects of the present disclosure can be understood by those skilled in the art in light of the description, the claims, and the drawings of the present disclosure.

### BRIEF DESCRIPTION OF THE DRAWINGS

FIG. 1 is an installation status diagram of an image-forming device and a processing cartridge;

FIG. 2 is a schematic diagram of the structure of an image-forming device;

FIG. 3 is a schematic diagram of the overall structure of a processing cartridge from an angle in accordance with Embodiment 1 of the present disclosure;

FIG. 4 is a schematic diagram of the overall structure of the processing cartridge from another angle in accordance with Embodiment 1;

FIG. 5 is a side view of the processing cartridge in accordance with Embodiment 1;

FIG. 6 is a schematic diagram of a partially exploded view of the processing cartridge in accordance with Embodiment 1;

FIG. 7 is a schematic diagram of the side partial structure of the driving side of the processing cartridge in accordance with Embodiment 1;

FIG. 8 is a schematic diagram of the overall structure of a processing cartridge in accordance with Embodiment 2 of the present disclosure;

FIG. 9 is a perspective view of the processing cartridge in accordance with Embodiment 2;

FIG. 10 is a schematic diagram of an exploded view of the driving side of the processing cartridge in accordance with Embodiment 2;

FIG. 11 is a perspective view of the processing cartridge in a free state/separated state in accordance with Embodiment 2;

FIG. 12 is a perspective view of the processing cartridge in a free state/separated state from another direction in accordance with Embodiment 2;

FIG. 13 is a cross-sectional view of the processing cartridge in a free state/separated state in accordance with Embodiment 2;

FIG. 14 is a schematic diagram of the first gear in accordance with Embodiment 2;

FIG. 15 is another cross-sectional view of the processing cartridge in a free state/separated state in accordance with Embodiment 2;

FIG. 16 is a perspective view of the processing cartridge in a contact state in accordance with Embodiment 2;

FIG. 17 is another perspective view of the processing cartridge in a contact state in accordance with Embodiment 2;

FIG. 18 is another perspective view of the processing cartridge in a contact state in accordance with Embodiment 2;

FIG. 19 is a cross-sectional view of the processing cartridge in a contact state in accordance with Embodiment 2;

FIG. 20 is a schematic diagram of the overall structure of a processing cartridge in accordance with Embodiment 3 of the present disclosure;

FIG. 21 is a schematic diagram of the partial structure of the processing cartridge in accordance with Embodiment 3, in which the end cover is omitted;

FIG. 22 is a schematic diagram of a transmission member of the processing cartridge in accordance with Embodiment 3;

FIG. 23 is a schematic diagram of the driving side end cover of the processing cartridge in accordance with Embodiment 3;

FIG. 24 is a schematic diagram of the first rotating member of the processing cartridge in accordance with Embodiment 3;

FIG. 25 is a cooperation diagram of the driving side end cover and the first rotating member of the processing cartridge in accordance with Embodiment 3;

FIG. 26 is a schematic diagram of the processing cartridge when the developing unit is in a separated position in accordance with Embodiment 3;

FIG. 27 is schematic diagram 1 of the cooperation process between the transmission member and the first rotating member of the processing cartridge in accordance with Embodiment 3;

FIG. 28 is schematic diagram 2 of the cooperation process between the transmission member and the first rotating member of the processing cartridge in accordance with Embodiment 3;

FIG. 29 is a schematic diagram of the processing cartridge when the developing unit is in a contact position in accordance with Embodiment 3;

FIG. 30 is a schematic diagram of the overall structure of a processing cartridge from an angle in accordance with Embodiment 4 of the present disclosure;

FIG. 31 is a schematic diagram of the overall structure of the processing cartridge from another angle in accordance with Embodiment 4;

FIG. 32 is a schematic diagram of a partially exploded view of the photosensitive coupling assembly of the processing cartridge in accordance with Embodiment 4;

FIG. 33 is a schematic diagram of the partial structure of a processing cartridge in accordance with Embodiment 4, in which the end cover is omitted;

FIG. 34 is a cooperation diagram of the developing coupling, the developing roller gear, the transmission member and the first rotating member of the processing cartridge in accordance with Embodiment 4;

FIG. 35A is a cooperation diagram of the gear part of the first rotating member when the angle is the smallest and the transmission member of the processing cartridge in accordance with Embodiment 4;

FIG. 35B is a cooperation diagram of the gear part of the first rotating member when the angle is the largest and the transmission member of the processing cartridge in accordance with Embodiment 4;

FIG. 36 is a schematic diagram of the overall structure of a processing cartridge in accordance with Embodiment 5 of the present disclosure;

FIG. 37 is a schematic diagram of an exploded view of the processing cartridge in accordance with Embodiment 5;

FIG. 38 is a process flow of the processing cartridge changing from a separated state to a contact state in accordance with Embodiment 5;

FIG. 39 is a schematic diagram of the back view of the connection between the delay mechanism and the developing tank cover in accordance with Embodiment 5;

FIG. 40 is a schematic diagram of the overall structure of a processing cartridge of in accordance with Embodiment 6;

FIG. 41 is a schematic diagram of a partial structure of the processing cartridge in accordance with Embodiment 6, in which the end cover is omitted;

FIG. 42 is a schematic diagram of the photosensitive coupling assembly of the processing cartridge in accordance with Embodiment 6;

FIG. 43 is a schematic diagram of an exploded view of the photosensitive coupling assembly and the second rotating member of the processing cartridge in accordance with Embodiment 6;

FIG. 44 is a schematic diagram of the second rotating member of the processing cartridge in accordance with Embodiment 6;

FIG. 45 is a schematic diagram of the driving side end cover of the processing cartridge in accordance with Embodiment 6;

FIG. 46 is a cooperation diagram of the driving side end cover and the second rotating member of the processing cartridge in accordance with Embodiment 6;

FIG. 47 is a schematic diagram of the processing cartridge when the developing unit is in a separated position in accordance with Embodiment 6;

FIG. 48 is a schematic diagram of the processing cartridge when the developing unit is in a contact position in accordance with Embodiment 6;

FIG. 49 is a schematic diagram of a processing cartridge when the developing unit is in a separated position in accordance with Embodiment 7 of the present disclosure;

FIG. 50 is a schematic diagram of the partial structure of the developing unit of the processing cartridge in accordance with Embodiment 7;

FIG. 51 is a schematic diagram of the third rotating member of the processing cartridge in accordance with Embodiment 7;

FIG. 52 is schematic diagram 1 of the cooperation process between the third rotating member and the photosensitive drum of the processing cartridge in accordance with Embodiment 7;

FIG. 53 is schematic diagram 2 of the cooperation process between the third rotating member and the photosensitive drum of the processing cartridge in accordance with Embodiment 7;

FIG. 54 is a schematic diagram of the processing cartridge when the developing unit is in a contact position in accordance with Embodiment 7.

FIG. 55 is a schematic diagram of the overall structure of a processing cartridge in accordance with Embodiment 8 of the present disclosure;

FIG. 56 is a schematic diagram of the structure of the processing cartridge in accordance with Embodiment 8, in which the end cover is omitted;

FIG. 57 is a schematic diagram of the connecting rod of the processing cartridge in accordance with Embodiment 8;

FIG. 58 is a schematic diagram of the ratchet wheel of the processing cartridge in accordance with Embodiment 8;

FIG. 59 is a schematic diagram of the processing cartridge when the developing unit is in a separated position in accordance with Embodiment 8, in which the end cover is omitted;

FIG. 60 is a schematic diagram of the processing cartridge when the developing unit is in a contact position in accordance with Embodiment 8, in which the end cover is omitted;

FIG. 61 is a schematic diagram of a processing cartridge in accordance with Embodiment 9;

FIG. 62 is a perspective view of the processing cartridge in accordance with Embodiment 9;

FIG. 63 is a schematic diagram of the processing cartridge in another direction in accordance with Embodiment 9;

FIG. 64 is a schematic diagram of an exploded view of the driving side of the processing cartridge in accordance with Embodiment 9;

FIG. 65 is a schematic diagram of an exploded view of the driving side of the processing cartridge from another direction in accordance with Embodiment 9;

FIG. 66 is a perspective view of the driving side of the processing cartridge in accordance with Embodiment 9;

FIG. 67 is an exploded view of the delay mechanism in accordance with Embodiment 9;

FIG. 68 is a schematic diagram of the delay mechanism in accordance with Embodiment 9;

FIG. 69 is a schematic diagram of the delay mechanism from another direction in accordance with Embodiment 9;

FIG. 70 is a schematic diagram of the processing cartridge in a free state/separated state in accordance with Embodiment 9;

FIG. 71 is a schematic diagram of the processing cartridge in a contact state in accordance with Embodiment 9;

FIG. 72 is a schematic diagram of the processing cartridge in a contact state from another direction in accordance with Embodiment 9;

FIG. 73 is an overall schematic diagram of a processing cartridge in accordance with Embodiment 10;

FIG. 74 is a schematic diagram of an exploded view of the processing cartridge in accordance with Embodiment 10;

FIG. 75 is a schematic diagram of the structure of the driving side end cover in accordance with Embodiment 10;

FIG. 76 is a schematic diagram of the structure of the separating mechanism in accordance with Embodiment 10;

FIG. 77 is a schematic diagram of the structure of the developing tank cover in accordance with Embodiment 10;

FIG. 78 to FIG. 81 are schematic diagrams of the contact process between the photosensitive drum in the photosensitive unit and the developing roller in the developing unit in accordance with Embodiment 10; and

FIG. 82 to FIG. 85 are schematic diagrams of the separation process of the photosensitive drum in the photosensitive unit and the developing roller in the developing unit in accordance with Embodiment 10.

### DETAILED DESCRIPTION

The present disclosure is further described in detail below in conjunction with the accompanying drawings. Apparently, the specific embodiments described herein are only some of the embodiments of the present disclosure. Based on the embodiments of the present disclosure, all other embodiments obtained by persons having ordinary skills in the art without making creative efforts should fall within the scope of protection of the present disclosure.

It should be noted that in this disclosure, relational terms, such as “first” and “second”, are only configured to distinguish one entity or operation from another entity or operation, and should not be understood as indicating or implying relative importance or implicitly indicating the number of the indicated technical features. Therefore, features defined as “first” or “second” may explicitly or implicitly include at least one of the features. In the present disclosure, the meaning of “plurality” is at least two, such as two, three, etc., unless otherwise clearly and specifically defined.

In the present disclosure, unless otherwise clearly specified and limited, the terms “installed”, “connected” and “fixed”, etc., should be understood in a broad sense. For example, a connection may be a fixed connection, a detachable connection, or an integral one, or it may be a mechanical connection, an electrical connection, or communication with each other. A connection may be a direct connection, or an indirect connection through an intermediate medium, or it may be the internal connection of two elements or the interactive relationship between two elements, unless otherwise clearly defined. For persons having ordinary skills in the art, the specific meanings of the above terms in the present disclosure may be understood according to specific circumstances.

In the present disclosure, unless otherwise clearly specified and limited, a first feature being “above” or “below” a second feature may mean that the first and second features are in direct contact, or that the first and second features are in indirect contact through an intermediate medium. Moreover, a first feature being “above” “over” and “atop” a second feature may mean that the first feature is directly above or obliquely above the second feature, or just that the first feature is higher in level than the second feature. A first feature being “below” “under” “underneath” a second feature may mean that the first feature is directly below or obliquely below the second feature, or just that the first feature is lower in level than the second feature.

In the above description, reference terms “one embodiment”, “some embodiments”, “example”, “specific example”, or “some examples” etc., mean that the specific features, structures, materials or characteristics described in conjunction with the embodiment or example are included in at least one embodiment or example of the present disclosure. In the present disclosure, the schematic representations of the above terms do not necessarily refer to the same embodiment or example. Moreover, the specific features, structures, materials or characteristics described may be combined in any one or more embodiments or examples in a suitable manner. In addition, persons skilled in the art may combine or assemble the different embodiments or examples described in this disclosure, or the features of the different embodiments or examples, provided there is no contradiction.

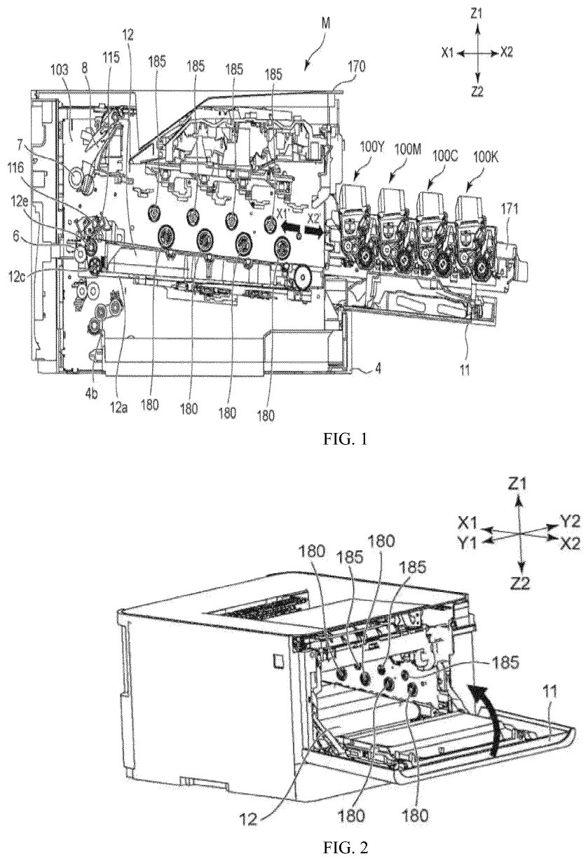

As shown in FIG. 1 and FIG. 2, a main assembly 170 of the image-forming device is configured with four processing cartridges 100 (100Y, 100M, 100C, 100K), namely a first processing cartridge 100Y, a second processing cartridge 100M, a third processing cartridge 100C and a fourth processing cartridge 100K. The processing cartridges are configured substantially horizontally. A rotational driving force is respectively supplied from a driving output part of the main assembly 170 of the image-forming device, and the main assembly 170 of the image-forming device provides bias voltages (charging bias, developing bias, etc.) to the first to fourth processing cartridges 100 (100Y, 100M, 100C, 100K). The processing cartridges are configured in the main assembly of the image-forming device through a tray 171. Specifically, the tray 171 is configured to be able to move in a substantially horizontal direction (such as the X1 and X2 directions of FIG. 1) when the main assembly 170 of the image-forming device is placed onto a horizontal surface, and the four processing cartridges are respectively placed into each positioned part of the tray. When the tray 171 is moved into the main assembly 170 of the image-forming device, the plurality of processing cartridges 100 are moved into the main assembly of the image-forming device together with the tray 171. When the processing cartridges need to be replaced, the plurality of processing cartridges may be moved together with the tray 171 to the outside of the main assembly 170 of the image-forming device.

As shown by FIG. 2, on the driving side, with the front door closed, a driving force is transmitted to a drum driving connector 180 on the main assembly side and a developing driving connector 185 on the main assembly side of the processing cartridge to allow them to protrude in the direction of arrow Y1 through a connecting rod mechanism (not shown). In addition, by opening the front door, the drum driving connector 180 and the developing driving connector 185 retract in the direction of arrow Y2. The purpose of doing so is, on the one hand, to better connect the drum driving connector 180 on the main assembly side and the developing driving connector 185 on the main assembly side with the photosensitive coupling and the developing coupling of the processing cartridges 100 respectively, so as to receive the driving force. On the other hand, it prevents the insertion and removal of the tray 171 from being hindered.

### Embodiment 1

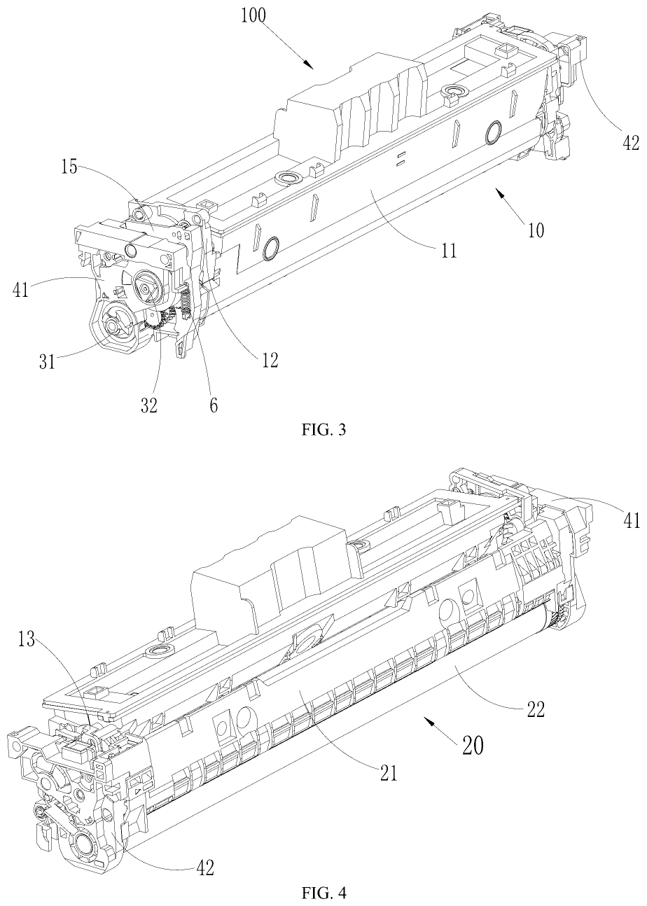

As shown in FIG. 3 and FIG. 4, Embodiment 1 of the present disclosure provides one processing cartridge, including a developing unit 10, a photosensitive unit 20 and a driving assembly. The developing unit 10 includes a developing frame 11, a developing roller, a powder feeding roller and a powder discharge knife. The photosensitive unit 20 includes a photosensitive frame 21, a photosensitive drum 22 and a charging roller.

As shown in FIG. 3, the developing frame 11 forms a powder bin for storing toner. The developing frame 11 is roughly in the shape of a long box. The developing frame 11 is configured with a driving side bearing 12 and a non-driving side bearing 13 at both ends along the length direction. The powder feeding roller and the developing roller are rotatably supported on the driving side bearing 12 and the non-driving side bearing 13 at both ends along the length direction of the developing frame 11. The powder feeding roller and the developing roller can rotate under an action of the driving assembly. The axial directions of the powder feeding roller and the developing roller are both configured along the length direction of the developing frame 11. The powder feeding roller transports the toner to the developing roller and is adsorbed by the charged developing roller.

As shown in FIG. 4, the photosensitive frame 21 also has a length direction, which is consistent with the length direction of the developing frame 11. The two ends of the photosensitive frame 21 along the length direction are respectively configured with a driving side end cover 41 and a non-driving side end cover 42. The photosensitive drum 22 is rotatably supported around its axis by the driving side end cover 41 and the non-driving side end cover 42. The photosensitive drum 22 is configured on the lower end side along the height direction of the photosensitive frame 21. The toner adsorbed by the developing roller is transferred to the photosensitive drum 22 through a potential difference between the developing roller and the photosensitive drum 22. The toner on the photosensitive drum 22 is then transferred by a transfer belt of the image-forming device to form an image on a recording material (such as paper). The charging roller is configured to charge the surface of the photosensitive drum 22 with a uniform charge so that the photosensitive drum 22 can adsorb the toner.

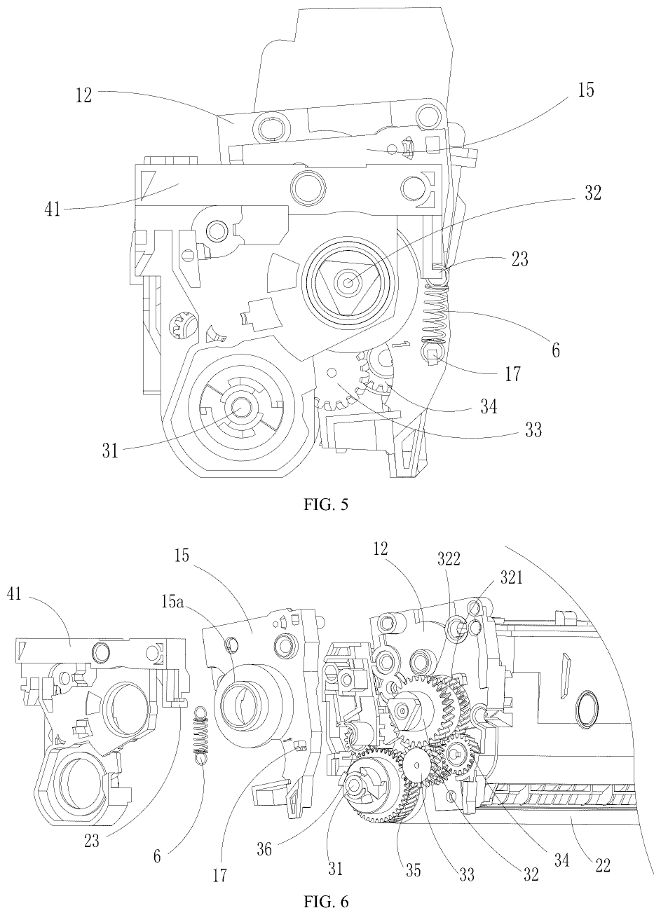

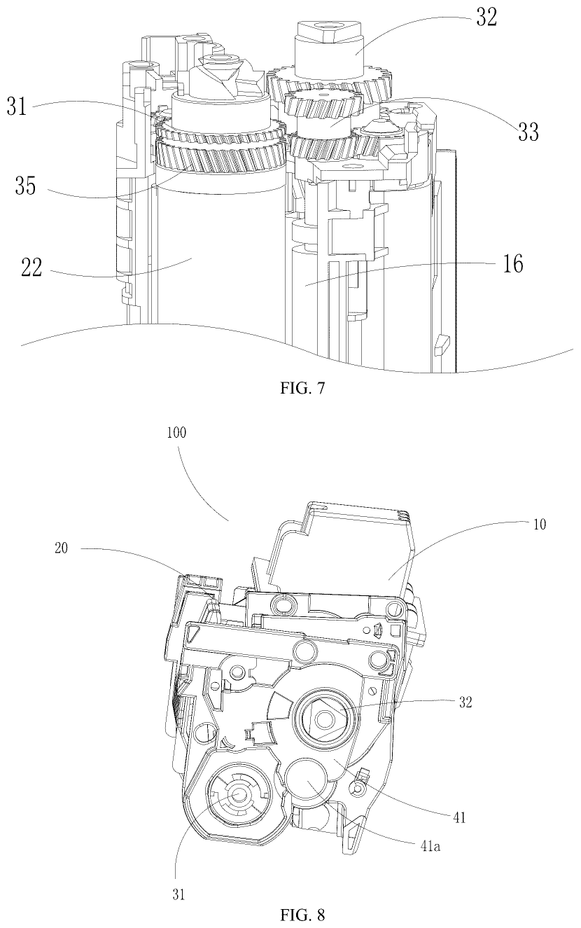

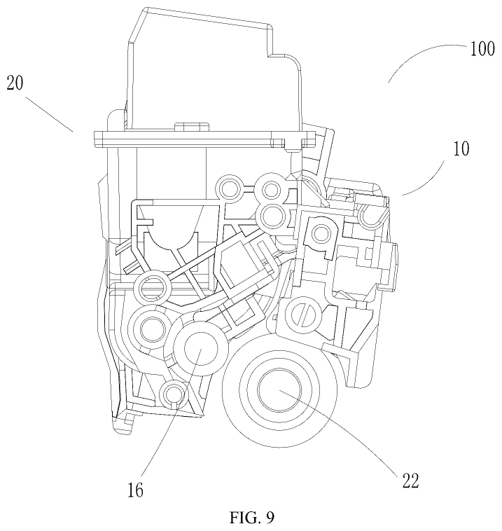

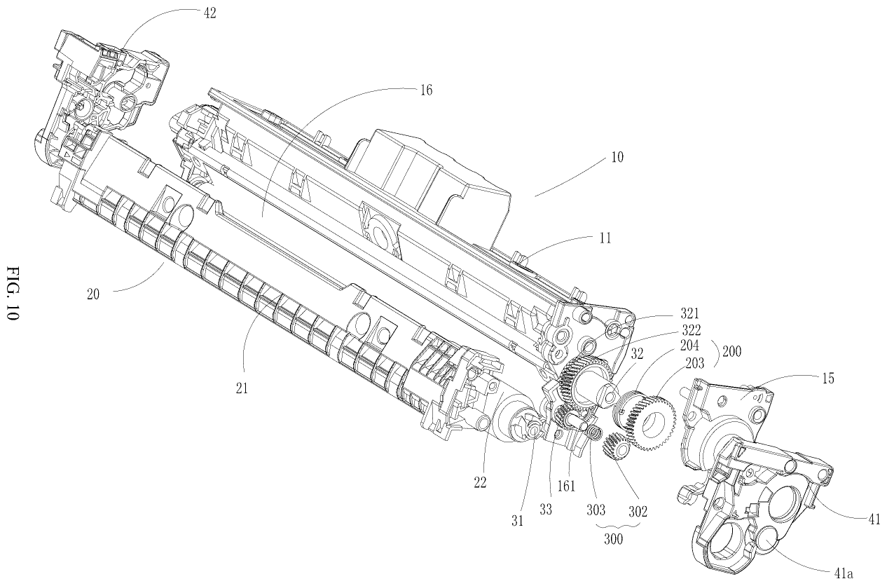

As shown in FIG. 5 to FIG. 7, the driving assembly includes a photosensitive coupling 31, a developing coupling 32, a developing roller gear 33 and a powder feeding roller gear 34. The driving assembly may be configured at one end or both ends of the processing cartridge 100 along the length direction. In the disclosed embodiment, the driving assembly is configured at the same end of the processing cartridge 100 along the length direction. The photosensitive coupling 31 is sleeved on one end along the length direction of the photosensitive drum 22. The photosensitive coupling 31 is configured to engage with the drum driving connector of the image-forming device, thereby receiving the rotational driving force of the image-forming device and driving the photosensitive drum 22 and the charging roller to rotate. The end of the photosensitive coupling 31 away from the end surface of the photosensitive frame 11 is configured with an engagement head, where the engagement head may be a regular or irregular protrusion, as long as it can engage with the drum driving connector and stably receive the driving force. The developing coupling 32, the developing roller gear 33, and the powder feeding roller gear 34 are configured on the outer side of the driving side bearing 12. Specifically, the driving side bearing 12 is configured with a supporting hole for supporting the developing coupling 32. The developing coupling 32 is configured as a double-gear structure for engaging with the driving force of the image-forming device to receive the driving force and transmit the driving force to different components. Specifically, the developing coupling 32 includes an engaging part and a transmission gear part coaxially configured with the engaging part, and the transmission gear part is closer to the driving side bearing 12 than the engaging part. The transmission gear part is a two-stage gear, including a first-stage gear 321 and a second- stage gear 322. The first-stage gear 321 is closer to the driving side bearing 12 than the second-stage gear 322, and the diameter of the first-stage gear 321 is smaller than the diameter of the second-stage gear 322. The engaging part and the transmission gear part may be configured as an integral part or a split structure and connected by means of snapping, pasting, welding, etc. The developing roller gear 33 is sleeved on one end of the developing roller shaft of the developing roller that extends out of the driving side bearing 12. The powder feeding roller gear 34 is sleeved on one end of the powder feeding roller shaft of the powder feeding roller that extends out of the driving side bearing 12. The developing roller gear 33 engages with the second-stage gear 322, and the powder feeding roller gear 34 engages with the first-stage gear 321, so as to transmit the driving force received by the developing coupling 32, thereby driving the developing roller and the powder feeding roller to rotate. Optionally, the transmission gear part may also be a first-stage gear, and the developing roller gear 33 and the powder feeding roller gear 34 both engage with the same-stage gear. In some embodiments, as shown in FIG. 6 and FIG. 7, the driving assembly includes a photosensitive coupling 31, a developing coupling 32, a developing roller gear 33, a powder feeding roller gear 34, a photosensitive drum gear 35, and a charging roller gear 36. The photosensitive coupling 31 is sleeved on one end of the photosensitive drum 22 along the length direction. The photosensitive coupling 31 is engaged with a drum driving connector of the image-forming device, thereby receiving the rotational driving force of the image-forming device and driving the charging roller through a peripheral gear. The photosensitive coupling 31 idles at one end of the photosensitive drum 22, that is, it does not drive the photosensitive drum to rotate, but only drives the photosensitive coupling 31 to rotate. The developing coupling 32, the developing roller gear 33, and the powder feeding roller gear 34 are configured on the outer side of the driving side bearing 12. The developing coupling 32 is configured as a double-gear structure for engaging with the driving force of the image-forming device to receive the driving force and transmit the driving force to different components. The developing roller gear 33 is a double-gear structure sleeved on the developing roller shaft of the developing roller extending from one end of the driving side bearing 12. The photosensitive drum gear 35 is integrally configured at one end of the photosensitive drum 22 and engages with one stage of gears of the developing roller gear 33 to receive the driving force transmitted by the developing coupling 32. Specifically, the developing coupling 32 receives the driving force from the image-forming device and transmits it to the developing roller gear 33, and then the developing roller gear 33 transmits the driving force to the photosensitive drum gear 35, thereby driving the photosensitive drum 22 to rotate.

As shown in FIG. 3, a developing box cover 15 is also configured on the outside of the driving side bearing 12. The developing box cover 15 covers the developing roller gear 33, the powder feeding roller gear 34 and some of the developing coupling 32, and can protect the driving assembly. Specifically, a cylindrical part 15a is configured on the developing box cover 15. The cylindrical part 15a protrudes along a side away from the developing frame 11. The cylindrical part 15a is hollow inside and extends axially along the length direction of the developing frame. When the engaging part of the developing coupling 32 protrudes outward along the axial direction, some of it passes through the inside of the cylindrical part 15a and protrudes out of the developing box cover 15.

As shown in FIG. 3 and FIG. 4, the non-driving side end cover 42 is configured to cover the outside of the non-driving side bearing 13, and the driving side end cover 41 is configured to cover the outside of the developing box cover 15. When viewed along the length direction of the processing cartridge 100, the driving side end cover 41 at least partially overlaps with the developing box cover 15. The driving side end cover 41 and the non-driving side end cover 42 respectively cover at least some of the ends of the photosensitive frame 21 and the developing frame 11.

In the disclosed embodiment, a first through hole and a second through hole are configured on the driving side end cover 41. When the driving side end cover 41 is disposed at the ends of the developing frame 11 and the photosensitive frame 21, some of the photosensitive coupling 31 is exposed through the first through hole, and some of the developing coupling 32 is exposed through the second through hole, so that the couplings engage with the driving connector of the image-forming device to receive the driving force.

During the operation of the image-forming device, the developing roller 16 and the photosensitive drum 22 must be in close contact. When the image-forming device is not in operation, the developing roller 16 and the photosensitive drum 22 must be separated by a certain distance to avoid long-term contact between the developing roller 16 and the photosensitive drum 22, which may cause problems such as the photosensitive drum 22 to be contaminated by excess developer attached to the developing roller 16, the developing roller 16 to be deformed, and the photosensitive drum 22 to be worn.

Therefore, in the disclosed embodiment, the developing unit 10 is configured to be movable relative to the photosensitive unit 20, so that the developing roller 16 and the photosensitive drum 22 may be in contact when the image-forming device is in operation and separated when not in operation. When the processing cartridge 100 is disposed in the image-forming device, the photosensitive unit 20 is pressed against a pressing component in the image-forming device, the photosensitive frame 21 is not movable, and the developing unit 10 is configured to be movable relative to the photosensitive unit 20 between a contact position and a separated position. When the developing unit 10 is in the contact position, the developing roller 16 contacts the photosensitive drum 22, and when the developing unit 10 is in the separated position, the developing roller 16 is separated from the photosensitive drum 22.

In the disclosed embodiment, the developing unit 10 moves in a manner of swinging with the axis of the developing coupling 32 as the rotation center. That is, when the developing unit 10 is in the contact position, the lower end of the developing unit 10 is close to the lower end of the photosensitive unit 20, so that the developing roller 16 can contact the photosensitive drum 22. At this moment, the upper end of the developing unit 10 is positioned away from the photosensitive unit 20. When the developing unit 10 moves from the contact position to the separated position, the lower end of the developing unit 10 swings in a direction away from the photosensitive unit 20, driving the developing roller 16 to separate from the photosensitive drum 22. At this moment, the upper end of the developing unit 10 swings in a direction close to the photosensitive unit 20. When the processing cartridge 100 is disposed in the image-forming device, the photosensitive unit 20 is relatively stationary with the image-forming device, and the end cover fixed to the photosensitive unit 20 is also stationary with respect to the photosensitive frame. When the developing unit 10 swings relative to the photosensitive frame, the developing box cover 15 also moves relative to the end cover with the axis of the developing coupling 32 as the rotation center.

As shown in FIG. 3 to FIG. 6, in the disclosed embodiment, the processing cartridge 100 is further configured with a separating mechanism, which is disposed between the photosensitive unit 20 and the developing unit 10. When the developing coupling stops rotating, the separating mechanism drives the developing unit 10 to move from the contact position to the separated position.

As shown in FIG. 6, in the disclosed embodiment, the separating mechanism is a separating elastic member 6 disposed between the photosensitive unit 20 and the developing unit 10. Specifically, the separating elastic member 6 may be a tension spring, where a first hook part 23 is configured on the driving side end cover 41, a second hook part 17 is configured on the developing box cover 15, and the tension spring is disposed between the two. A force acts on the developing unit 10 so that its lower end tends to rotate around a rotation center away from the photosensitive unit 20. Therefore, when the processing cartridge 100 stops the developing process, the developing unit 10 is always kept in the separated position due to the action of the separating elastic member 6. When the developing coupling 32 receives the driving force from the image-forming device and starts to rotate, the torque and friction exerting force on the developing unit 10 is much greater than the force exerted by the tension spring on the developing unit 10. Therefore, the lower end of the developing unit 10 moves toward the direction close to the photosensitive unit 20, so that the developing unit 10 moves from the separated position to the contact position. At this moment, the processing cartridge 100 is in a developing contact state and performs the developing process.

In the disclosed embodiment, the friction is mainly generated from the engaging of gears between the driving assemblies. Specifically, a large sliding friction is generated between the developing coupling 32 and the developing roller gear 33. At the same time, the joined part between the end cover 41 and the developing unit 10 also generates friction. The sum of the above frictions is much greater than the force of the separating elastic member 6.

In some embodiments, the source of friction may also be obtained by configuring a friction resistance member. Optionally, a damper or the like may be configured on the developing coupling 32.

In the disclosed embodiment, the processing cartridge 100, by means of the separating elastic member 6 disposed between the developing unit 10 and the photosensitive unit 20 and by utilizing the torque and friction of the rotating developing coupling 32, realizes the following: when the image-forming device is in a developing process, the photosensitive drum 22 maintains contact with the developing roller 16, and when it stops developing, the photosensitive drum 22 and the developing roller 16 remain separated. This solves the technical problem in the existing technology of long-term contact between the photosensitive drum 22 and the developing roller 16, which causes the deposition of colorant on the photosensitive drum 22 and therefore contaminates the photosensitive drum 22. It also solves the technical problem of long-term friction between the photosensitive drum 22 and the developing roller 16, which accelerates the deterioration of the developing roller 16 or the developer. The structure of the disclosed embodiment is simple and easy to implement, which prolongs the service life of the processing cartridge 100 and enhances the stability of use.

### Embodiment 2

Embodiment 2 of the present disclosure provides another processing cartridge, which is different from Embodiment 1 in that a delay mechanism is also provided.

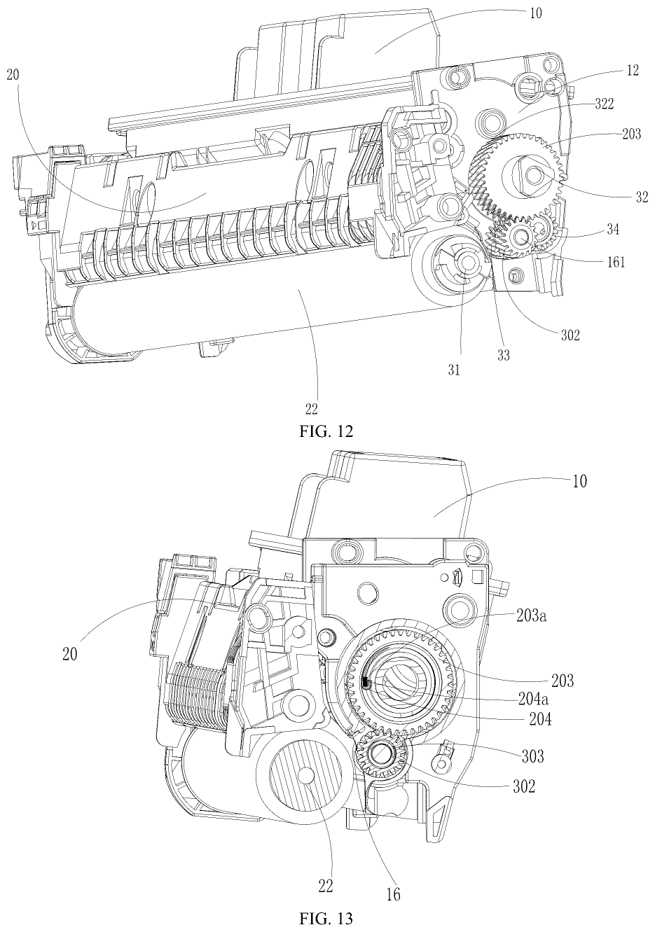

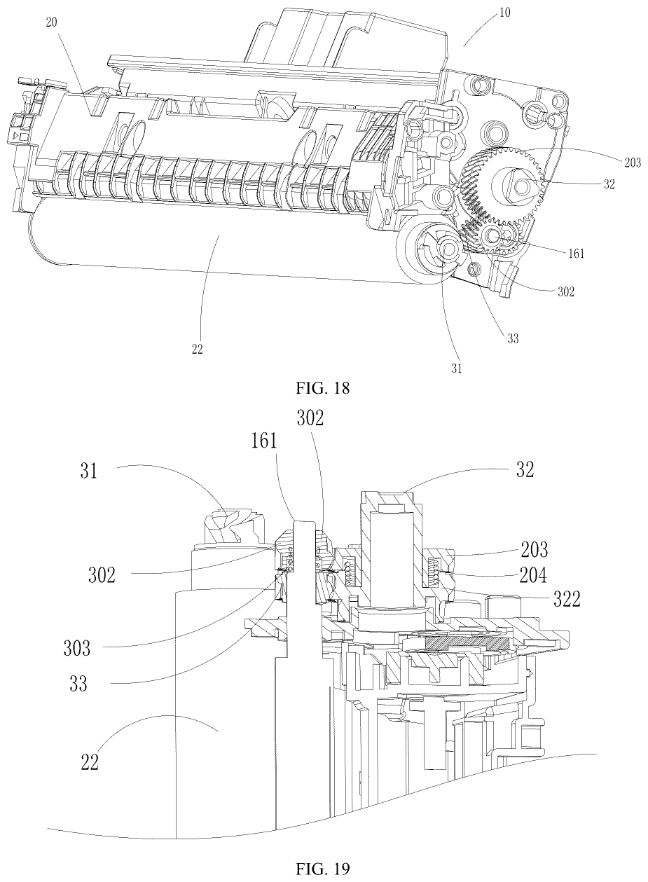

As shown in FIG. 10 to FIG. 19, a processing cartridge 100 also includes a delay mechanism for prolonging the time required for the developing unit to move from a separated position to a contact position. The delay mechanism is configured at one end of the developing unit 10 on the driving side. The delay mechanism includes a first delay assembly 200 and a second delay assembly 300, that is, the first delay assembly 200 is coaxially configured with the developing coupling 32 and the second delay assembly 300 is coaxially configured with the developing roller 16.

As shown in FIG. 10 to FIG. 19, the first delay assembly 200 includes a first gear 203 and a first torsion spring 204. The first gear 203 is coaxially configured with the developing coupling 32, and is specifically sleeved on the cylindrical part of the developing coupling 32. The developing coupling 32 and the first gear 203 have an indirect transmission connection, that is, when the developing coupling 32 rotates, the first gear 203 does not rotate directly. The first torsion spring 204 is disposed between the first gear 203 and a second-stage gear 322, and the first gear 203 can move close to or away from the second-stage gear 322 under the action of the first torsion spring 204.

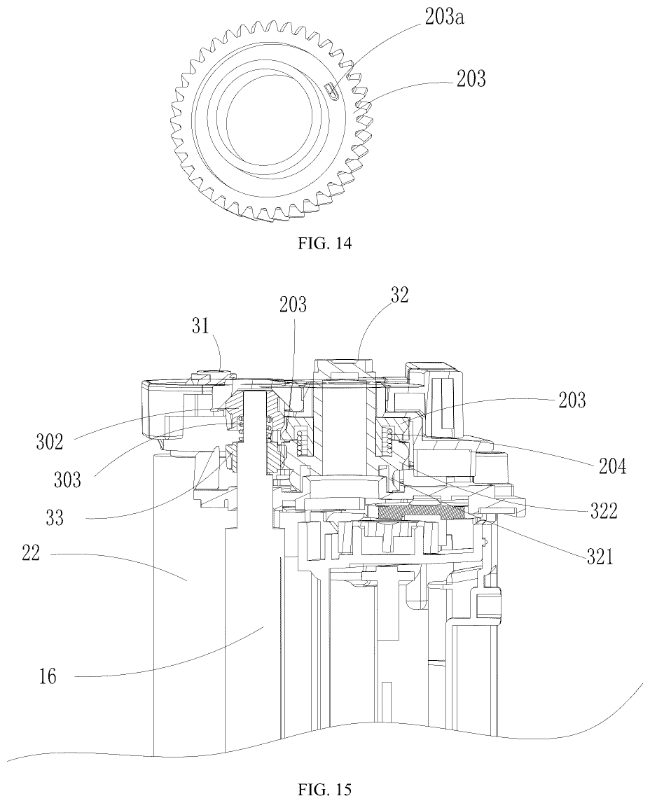

As shown in FIG. 13 and FIG. 14, a hook part 204a is configured at the end of the first torsion spring 204 close to the first gear 203, and an engaged part 203a matching the hook part 204a is configured on the corresponding first gear 203. When the developing coupling 32 rotates around the rotation center, the second-stage gear 322 also rotates accordingly, the first torsion spring 204 is tightened, and the hook part 204a thereon is clamped with the engaged part 203a on the first gear 203, thereby driving the first gear 203 to rotate. Here, the engaged part may be a convex part, a concave part, or other shapes, as long as it matches the hook part. When the first torsion spring 204 is tightened, it will retract toward the direction close to the second-stage gear 322, and while driving the first gear 203 to rotate, it will also pull the first gear 203 to move toward the direction close to the second-stage gear 322. When the developing coupling 32 stops rotating, the second-stage gear 322 also stops rotating, the torque on the first torsion spring 204 disappears, and the deformed first torsion spring 204 restores and stretches in the direction away from the second-stage gear 322, pushing the first gear 203 to move in the direction away from the second-stage gear 322.

As shown in FIG. 10 to FIG. 13, the second delay assembly 300 includes a second gear 302 and a second torsion spring 303. The second gear 302 is coaxially configured with a developing roller shaft 161, and does not rotate directly therewith, but the second gear 302 will engage with the first gear 203 and rotate therewith. The second gear 302 is located on the outside of the developing roller gear 33 (that is, the developing roller gear 33 is close to the driving side bearing 12, and the second gear is close to the developing box cover 15). The developing roller gear 33 engages with the second-stage gear 322 on the first delay assembly 200. The second torsion spring 303 is sleeved on the developing roller shaft 161 and is located between the developing roller gear 33 and the second gear 302, and the second torsion spring 303 is connected to the second gear 302.

As shown in FIG. 10, one end of the developing roller shaft 161 passes through the second delay assembly 300 and abuts against a concave part 41a on the inner side of the driving side end cover 41.

In the disclosed embodiment, all gears on the delay mechanism are configured as helical teeth, and the helical teeth direction of the first gear 203 of the first delay assembly 200 is the same as the helical teeth direction of the first-stage gear 321 and the second-stage gear 322. The helical teeth direction of the second gear 302 of the second delay assembly 300 is the same as the helical teeth direction of the developing roller gear 33, but the helical teeth direction on the first delay assembly 200 is different from the helical teeth direction on the second delay assembly 300. That is, starting from the end of the helical teeth close to the driving side end cover 41, the helical teeth on the first-stage gear 321, the second-stage gear 322, and the first gear 203 are all inclined and extended in a direction close to the photosensitive drum 22. The helical teeth on the developing roller gear 33 and the second gear 302 are all inclined and extended in a direction away from the photosensitive drum 22. When the gear of the first delay assembly 200 rotates clockwise, the gear of the second delay assembly 300 rotates counterclockwise.

After the image-forming device receives an operating instruction and is in the developing operation, the developing coupling 32 rotates, thereby driving the delay mechanism and the developing roller 16 to rotate together. When the operating instruction is completed, the developing operation ends, the developing coupling 32 stops rotating, and the developing roller 16 and the delay mechanism also stop rotating.

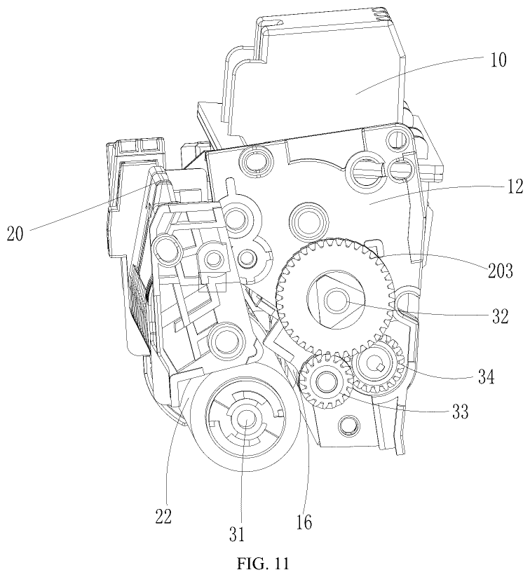

As shown in FIG. 11 to FIG. 15, when the image-forming device does not receive an operating instruction, the developing coupling 32 and the developing roller 16 are in a stationary state. At this moment, the first gear 203 and the second gear 302 of the delay mechanism are in a free state, and are away from the second-stage gear 322 and the developing roller gear 33 under the natural forces of the first torsion spring 204 and the second torsion spring 303. The developing roller 16 is then separated from the photosensitive drum 22.

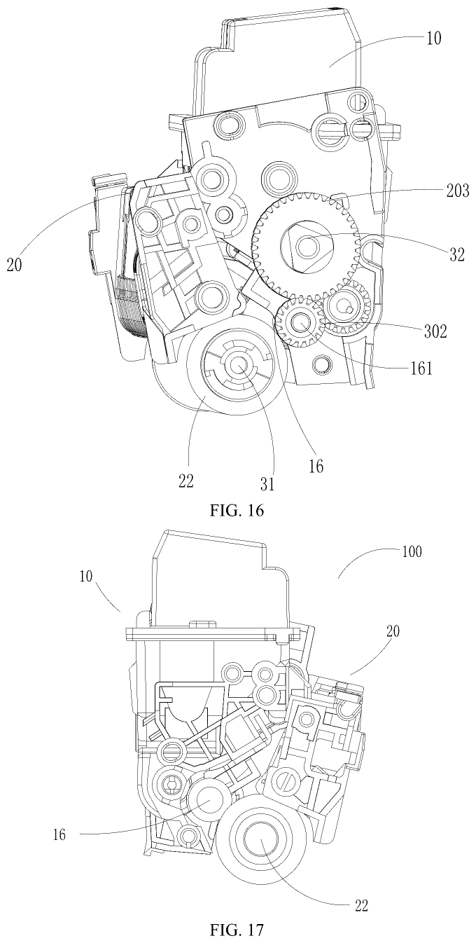

As shown in FIG. 16 to FIG. 19, when the image-forming device receives an operating instruction, the developing coupling 32 starts to rotate, and the first-stage gear 321 and the second-stage gear 322 thereon start to rotate. When the second-stage gear 322 rotates, the developing roller gear 33 on the developing roller shaft 161 is driven to rotate together, and the second torsion spring 303 is tightened. The developing coupling 32 rotates, the first torsion spring 204 is tightened, and when the hook part 204a cooperates with the engaged part 203a on the first gear 203, the first gear 203 is driven to rotate accordingly and move closer to the second-stage gear 322. At this moment, the second gear 302 also rotates while engaging with the first gear 203, the second gear 302 also moves toward the direction close to the developing roller gear 33, and the second torsion spring 303 is tightened again. Because the direction of the helical teeth on the first gear 203 is different from that on the second gear 302, under the action of the rotational force, the first gear 203 pushes the second gear 302 toward the direction of the photosensitive drum 22, that is, the second gear 302 drives the developing roller 16 to move closer to the photosensitive drum 22, and the developing roller 16 contacts the photosensitive drum 22 to realize the developing.

When the image-forming device finishes the operation, the developing coupling 32 stops rotating, the first-stage gear 321 and the second-stage gear 322 stop rotating, then the developing roller gear 33 configured on the developing roller shaft 161 stops rotating, and the developing roller 16 stops rotating. Because the first torsion spring 204 and the second torsion spring 303 are tightened during the developing process, in the absence of the driving force, the elastic force of the first torsion spring 204 and the second torsion spring 303 will be released instantly, so that under the elastic force of the first torsion spring 204, the first gear 203 moves away from the second-stage gear 322, and the second gear 302 also moves away from the developing roller gear 33 under the action of the first gear 203 and the elastic force of the second torsion spring 303. At this moment, the developing roller 16 is separated from the photosensitive drum 22 under the force of the second gear 302. When the image-forming device receives an operating instruction again, the above actions will continue to be repeated.

In the processing cartridge of the disclosed embodiment, after the developing coupling 32 receives the driving force, it is necessary to drive the delay mechanism to operate before the developing unit 10 can move from the separated position to the contact position, instead of the developing coupling 32 immediately making the developing roller move close and contact the photosensitive drum under the action of torque after receiving the driving force. This prolongs the time for the developing unit 10 to move from the separated position to the developing position, delays the time point when the developing roller 16 contacts the photosensitive drum, and ensures that the developing roller 16 and the photosensitive drum 22 are in contact only after they are fully rotated, thereby ensuring the developing quality.

The other structures of the processing cartridge of Embodiment 2 are the same as those of Embodiment 1 and will not be described again in detail here.

### Embodiment 3

Embodiment 3 of the present disclosure provides another processing cartridge. Compared with Embodiment 2, the structure of the delay mechanism of the embodiment disclosed herein is different.

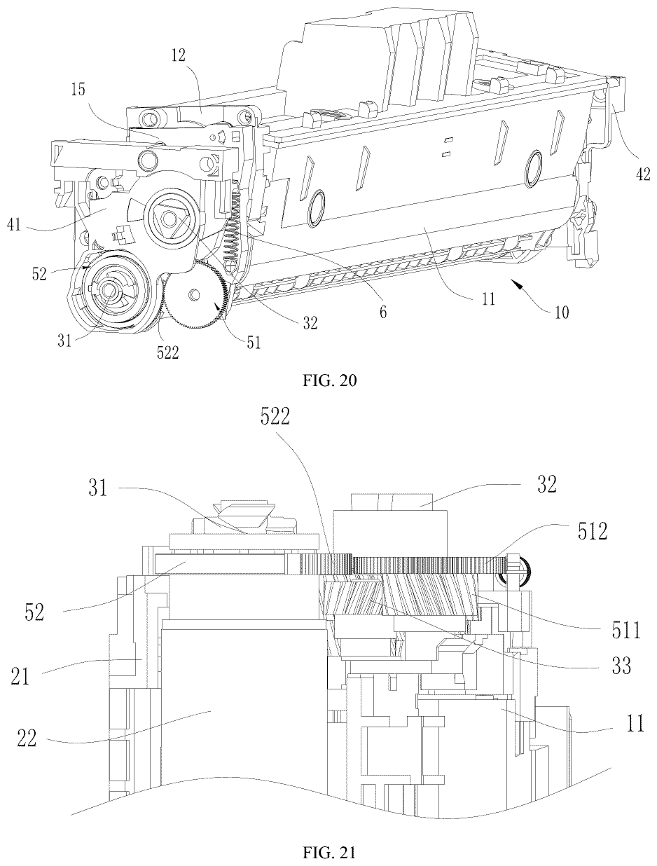

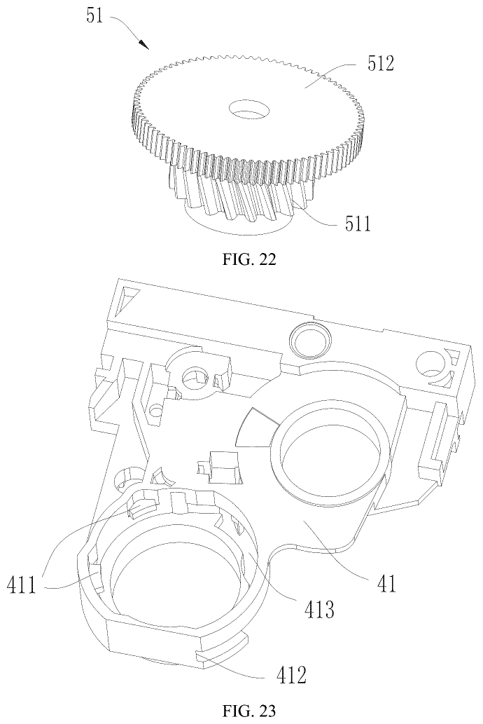

As shown in FIG. 20 to FIG. 22, the processing cartridge also includes a delay mechanism, which includes a first rotating member 52 and a transmission member 51, which are configured to prolong the time required for the developing unit 10 to move from a separated position to a contact position. The transmission member 51 is configured on the developing unit 10 and can receive a driving force of the driving assembly to rotate. Specifically, a pillar is configured on a driving side bearing 12, and the transmission member 51 is rotatably supported on the pillar. The transmission member 51 is configured near the lower end of the developing unit 10 along the height direction. The transmission member 51 includes a third gear 511 and a fourth gear 512 configured coaxially. In the axial direction, the third gear 511 is closer to the driving side bearing 12 than the fourth gear 512. The third gear 511 engages with the developing roller gear 33, thereby receiving the driving force to rotate the transmission member 51.

Optionally, the third gear 511 may also engage with the powder feeding roller gear or the developer coupling 32 to receive the driving force. The fourth gear 512 is configured to engage with the first rotating member 52 to transmit the driving force to the first rotating member 52, and the diameter of the fourth gear 512 is greater than the diameter of the third gear 511.

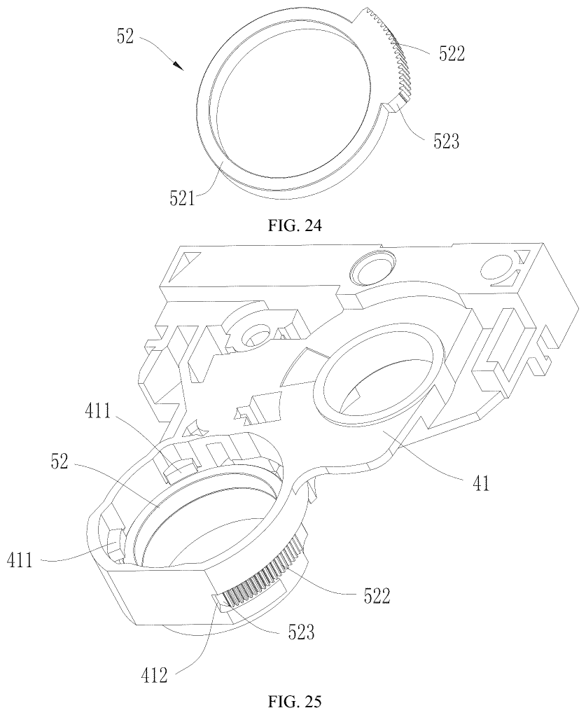

As shown in FIG. 20, FIG. 21, and FIG. 23 to FIG. 25, the first rotating member 52 is configured on the photosensitive unit 20, and can receive the driving force of the transmission member 51 to rotate. Specifically, a slot part is configured on the driving side end cover 41, and the slot part is configured around a first through hole. The first rotating member 52 is configured in the slot part, and a positioning part 411 is configured on the inner wall of the slot part. The positioning part 411 may be one or more protrusions. The positioning part 411 abuts against the end of the first rotating member 52 away from a photosensitive frame 21, thereby limiting the axial movement of the first rotating member 52 and preventing the first rotating member 52 from coming out from the slot part. The first rotating member 52 includes a ring part 521 and a gear part 522 configured on the circumferential surface of the ring part 521. When the photosensitive coupling 31 at one end of the photosensitive drum 22 extends from the first through hole, it passes through the ring part 521 and is supported by the ring part 521, that is, the ring part 521 is sleeved on the photosensitive coupling 31. The gear part 522 has only one section of teeth, and the ring part 521 is not configured with teeth all around. The radius of the gear part 522 is greater than the radius of the ring part 521. A section of opening 413 that is circumferentially extending is configured on the slot part wall of the slot part of the driving side end cover 41, and the opening 413 is located on the side of the slot part close to the developing unit 10. The gear part 522 of the first rotating member 52 extends into the opening 413 and is exposed through the opening 413. The arc length corresponding to the opening 413 is greater than the arc length corresponding to the gear part 522. The gear part 522 can rotate within the arc length range of the opening 413. A rotation-stopping surface 523 is configured at one end of the gear part 522 in the circumferential direction, and a stopper 412 is configured at one end of the opening 413 in the circumferential direction. When the rotation-stopping surface 523 abuts against the stopper 412, the first rotating member 52 cannot rotate in the clockwise direction. The position where the rotation-stopping surface 523 abuts against the stopper 412 is also the initial position of the first rotating member 52. The first rotating member 52 can receive the driving force and rotate by engaging with the fourth gear 512 of the transmission member 51 through the gear part 522. The gear part 522 is exposed through the opening 413 so as to engage with the fourth gear 512.

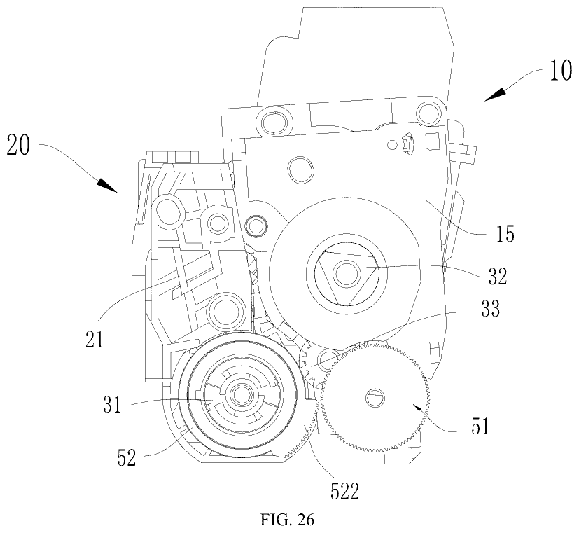

As shown in FIG. 20 and FIG. 26, during the transmission and storage stage before the processing cartridge is used, it is also necessary to avoid long-term contact between the developing roller and the photosensitive drum 22. In the disclosed embodiment, the processing cartridge also includes a separating elastic member 6, which may be a tension spring, one end of which is connected to the driving side end cover 41, and the other end is connected to the developing box cover 15. Due to the tension of the tension spring acting on the developing unit 10, the lower end of the entire developing unit 10 tends to rotate around a rotation center away from the photosensitive unit 20, so that the lower end of the developing unit 10 is away from the lower end of the photosensitive unit 20, and the photosensitive drum 22 does not contact the developing roller.

As shown in FIG. 26, before the processing cartridge receives the force (driving force) of the image-forming device, the processing cartridge is in an initial state, the developing unit 10 is maintained in the separated position under the force of the separating elastic member 6, and the developing roller is separated from the photosensitive drum 22. At this moment, the transmission member 51 and the first rotating member 52 configured near the lower end of the developing unit 10 are separated from each other, and the two are not in contact. The first rotating member 52 is in the initial position where the rotation-stopping surface 523 abuts against the stopper 412.

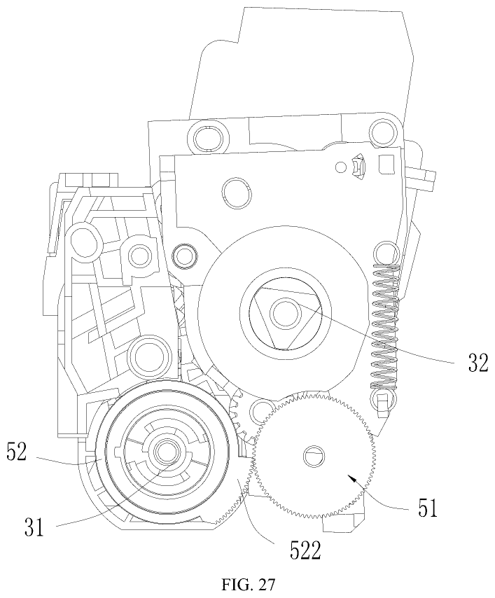

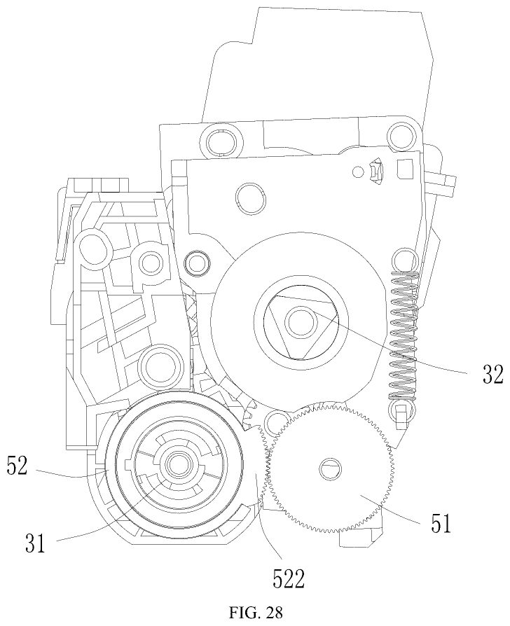

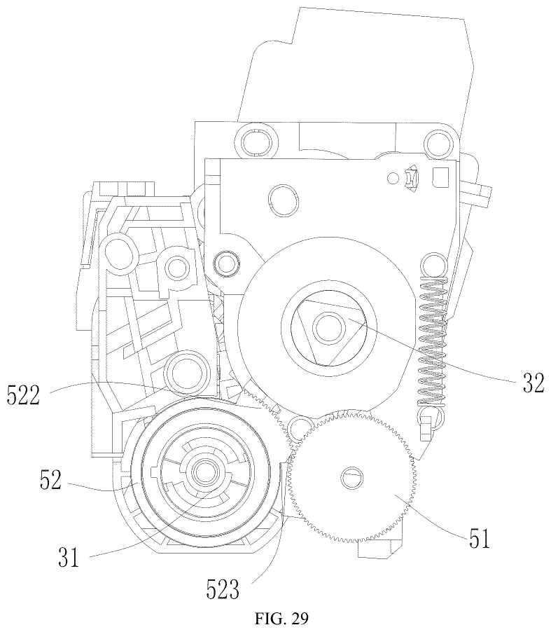

As shown in FIG. 27 and FIG. 28, when a developing operation is required, the developing driving connector of the image-forming device is engaged with the developing coupling 32 of the developing unit 10, and the developing coupling 32 receives the driving force and starts to rotate, driving the developing roller gear 33 to rotate, and the developing roller gear 33 then drives the transmission member 51 to rotate. Due to the large torque of the driving force and the friction (when the developing driving connector is engaged with the developing coupling 32, part of the developing driving connector will contact the developing box cover 15, and a friction will be generated between the two when the developing driving connector rotates), a force (this force can overcome the force of the separating elastic member 6) can be generated to move the developing unit 10 from the separated position to the contact position. That is, the lower end of the developing unit 10 moves toward the lower end of the photosensitive unit 20, and the transmission member 51 follows the developing unit 10 to move toward the photosensitive unit 20 to a position where it can engage with the gear part 522 of the first rotating member 52. Through the engaging of the fourth gear 512 with the end of the gear part 522 away from the rotation-stopping surface 523, the rotational driving force of the transmission member 51 is transmitted to the first rotating member 52, and the first rotating member 52 starts to rotate counterclockwise. At this moment, the developing roller and the photosensitive drum 22 have not yet contacted. As shown in FIG. 29, when the first rotating member 52 rotates to the position where the rotation-stopping surface 523 contacts the fourth gear 512, the gear part 522 is disengaged from the fourth gear 512, and the first rotating member 52 can no longer be driven to rotate by the transmission member 51. Due to the action of the large torque driven by the driving force and the friction, the lower end of the developing unit 10 continues to move toward the photosensitive drum 22 to the contact position, and the developing roller contacts the photosensitive drum 22, so that the developing operation can be carried out. The delay mechanism is configured to ensure that the developing roller 16 and the photosensitive drum 22 can only contact after rotating through the stroke of the gear part 522, thereby prolonging the time for the developing unit 10 to move from the separated position to the developing position, so that the time point when the developing roller 16 contacts the photosensitive drum is delayed. This can ensure that the developing roller 16 and the photosensitive drum 22 are in contact only after they are fully rotated, thereby ensuring developing quality.

As shown in FIG. 26 to FIG. 29, when the image-forming device finishes the developing operation, the developing driving connector of the image-forming device stops rotating. Since the developing driving connector stops rotating, the developing driving force disappears, and the force of the separating elastic member 6 on the developing unit 10 drives the developing unit 10 to rotate in a direction away from the photosensitive drum 22 toward the separated position, and the developing roller is separated from the photosensitive drum 22. At the same time, the transmission member 51 moves with the developing unit 10 away from the first rotating member 52 and disengages from the rotation-stopping surface 523. Since the first rotating member 52 is sleeved on the photosensitive coupling 31, under the action of the friction between the photosensitive coupling 31 and the first rotating member 52, the first rotating member 52 rotates clockwise to the initial position where the rotation- stopping surface 523 abuts against the stopper 412 of the driving side end cover 41. Then, the drum driving connector stops rotating, and the photosensitive coupling 31 and the photosensitive drum 22 also stop rotating.

In some embodiments, the first rotating member 52 may be restored to its initial position by configuring a separating elastic member. The separating elastic member is disposed between the first rotating member 52 and the driving side end cover 41. When the first rotating member 52 is driven by the transmission member 51 to rotate counterclockwise, the separating elastic member is deformed. When the developing process is finished, the elastic deformation of the separating elastic member is restored to make the first rotating member 52 rotate clockwise and return to its initial position.

In some embodiments, the first rotating member 52 may not be configured with the gear part 522, and the transmission member 51 may not be configured with the fourth gear 512. A surface with greater friction may be disposed between the two, and the transmission member 51 drives the first rotating member 52 to rotate through friction.

It should be noted that the delay mechanism of the embodiment disclosed herein is configured at the driving side of the processing cartridge, and may also be configured at the non-driving side opposite to the driving side, and may also be configured at both the driving side and the non-driving side of the processing cartridge.

The other structures of the processing cartridge of Embodiment 4 are the same as those of Embodiment 1 and will not be described again in detail here.

### Embodiment 4

Embodiment 4 of the present disclosure provides another processing cartridge, which is the same as Embodiment 1, except that the structure of the photosensitive coupling is different. The structure and operating mode of the delay mechanism of the embodiment disclosed herein are the same as those of Embodiment 3, except that the number of teeth of the gear part of the first rotating member is different.

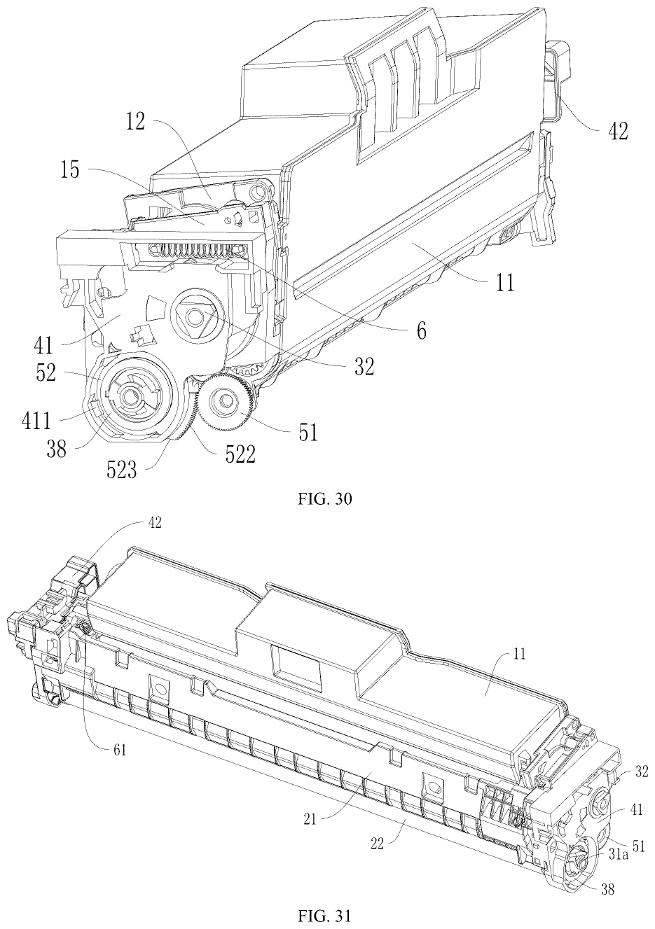

In the disclosed embodiment, the processing cartridge does not have an integrated photosensitive coupling, but a photosensitive coupling assembly is configured at one end of the photosensitive drum 22. As shown in FIG. 30 to FIG. 32, the photosensitive coupling assembly includes a sleeve 37, a friction component 38 and an engaging part 31a. The sleeve 37 is a cylindrical member fixedly configured at one end of the photosensitive drum 22 in the length direction. The sleeve 37 and the photosensitive drum 22 may be integrally formed or may be a separate structure. The sleeve 37 is hollow inside and has an opening at one end away from the photosensitive drum 22. The engaging part 31a is configured inside the sleeve 37 and can rotate inside the sleeve 37. Some of the engaging part 31a extends from the opening of the sleeve 37 to engage with a driving member inside the drum driving connector of the image-forming device. The extended part of the engaging part 31a may be a regular or irregular protrusion. The friction component 38 is an annular member, which is sleeved on the end surface of the sleeve 37 away from the photosensitive drum 22 and is fixed to the sleeve 37. Specifically, a positioning part 371 is configured at the end of the sleeve 37 away from the photosensitive drum 22, and a positioned part 381 is configured on the friction component 38. The positioning part 371 may be a convex block, and the positioned part 381 may be a concave slot matching the convex block. The concave slot may be configured on the inner wall of the friction component 38. When the friction component 38 is assembled, the positioning part 371 cooperates with the positioned part 381, thereby limiting the position of the friction component 38 on the sleeve 37. There may be multiple positioning parts 371 and positioned parts 381, which are distributed along the circumferential direction of the sleeve 37 and the friction component 38. The friction component 38 is made of an elastic material (such as rubber) with a large friction, that is, the friction component 38 is a rubber ring, one end surface of the friction component 38 contacts the end surface of the sleeve 37 away from the photosensitive drum 22, and the other end surface is a friction surface 38a. An adhesive may be applied to the end surface of the sleeve 37 away from the photosensitive drum 22 to stick and fix the friction component 38. When the processing cartridge is installed in the image-forming device, the end surface of the shell of the drum driving connector abuts against the friction component 38, and a large friction is generated between the drum driving connector and the friction component 38 when the drum driving connector rotates, thereby driving the friction component 38 and the sleeve 37 connected to the friction component 38 to rotate, and then driving the photosensitive drum to rotate. When the drum driving connector rotates, the driving member also rotates, driving the engaging part 31a engaged with it to rotate in the sleeve 37, but the driving force of the engaging part 31a is not transmitted to the photosensitive drum 22.

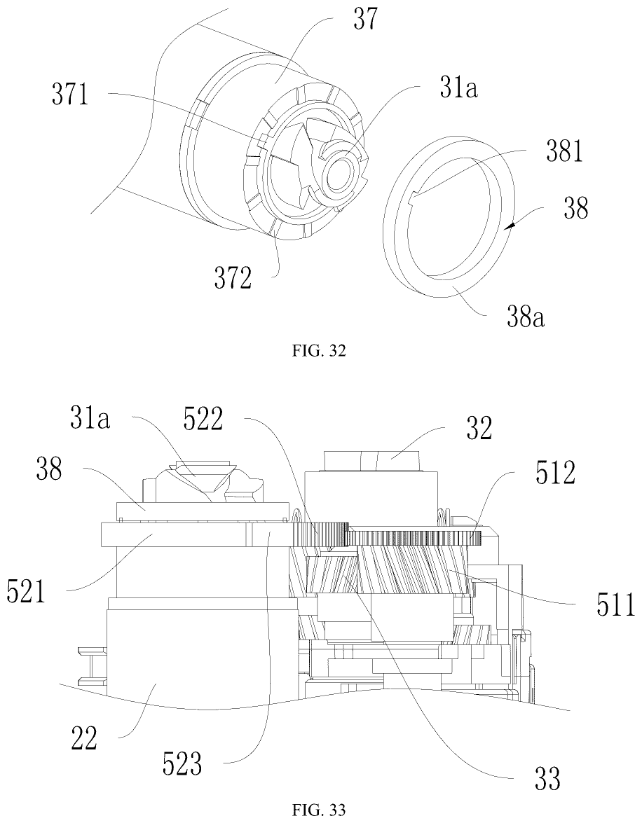

Further, as shown in FIG. 32, at least one protrusion 372 is configured on the end surface of the sleeve 37 away from the photosensitive drum 22, and the protrusion 372 can increase the friction between the sleeve 37 and the friction component 38. Preferably, a plurality of protrusions 372 are configured, which are configured at intervals along the circumference of the sleeve 37. In addition, the contact and cooperation between the positioning part 371 and the positioned part 381 can also play a role in increasing the friction between the friction component 38 and the sleeve 37.

As shown in FIG. 31, the processing cartridge also includes a first elastic member 61, which may be a spring, one end of which abuts against the photosensitive frame 21, and the other end abuts against the developing frame 11, and the first elastic member 61 is located at the upper end of the processing cartridge. The force of the first elastic member 61 makes the lower end of the developing unit 10 tend to rotate around a rotation center close to the photosensitive unit 20, and makes the developing roller tend to move close to the photosensitive drum 22, but the force of the first elastic member 61 is less than the force of the separating elastic member 6. The first elastic member 61 can counter some of the force of the separating elastic member 6, but cannot make the developing unit 10 move to the position where the developing roller contacts the photosensitive drum 22, that is, the processing cartridge is still in a state where the developing roller is separated from the photosensitive drum 22 before use.

When a developing operation is required, the driving member of the drum driving connector of the image-forming device engages with the engaging part 31a, and the end surface of the shell of the drum driving connector abuts against and compresses the friction component 38. When the drum driving connector rotates, it generates a relatively large friction with the friction component 38 to transmit the driving force to the photosensitive drum through the sleeve 37. It should be noted that in the disclosed embodiment, the engaging part 31a may be idlingly configured in the sleeve 37, and the driving member of the drum driving connector of the image-forming device engages with the engaging part 31a, which only ensures the stability of the driving force transmission, so that the driving member and the engaging part 31a does not come out in the axial direction. The engaging part 31a does not transmit the driving force to the photosensitive drum 22. When the photosensitive drum starts to rotate, and the first rotating member 52 does not rotate with the sleeve 37 because the rotation-stopping surface 523 abuts against the stopper 412. At the same time, the developing driving connector of the image-forming device is engaged with the developing coupling 32 of the developing unit 10, and the developing coupling 32 receives the driving force and starts to rotate, driving the developing roller gear 33 to rotate, and the developing roller gear 33 then drives the transmission member 51 to rotate. Due to the large torque of the driving force and the friction (when the developing driving connector is engaged with the developing coupling 32, part of the developing driving connector will contact the developing box cover 15, and a friction will be generated between the two when the developing driving connector rotates), a force can be generated to move the developing unit 10 from a second position to a first position (this force can overcome the force of the separating elastic member 6). That is, the lower end of the developing unit 10 moves toward the direction close to the lower end of the photosensitive unit 20, and the transmission member 51 follows the developing unit 10 to move toward the direction close to the photosensitive unit 20 to a position where it engages with the gear part 522 of the first rotating member 52, and engages with the end of the gear part 522 away from the rotation-stopping surface 523 through the fourth gear 512. The rotational driving force of the transmission member 51 is transmitted to the first rotating member 52, and the first rotating member 52 starts to rotate counterclockwise. At this moment, the developing roller and the photosensitive drum 22 do not contact each other. When the first rotating member 52 rotates to a position where the rotation-stopping surface 523 contacts the fourth gear 512, the gear part 522 disengages from the fourth gear 512, and the first rotating member 52 can no longer be driven by the transmission member 51 to rotate. Due to the large torque driven by the driving force and the friction, the lower end of the developing unit 10 continues to move toward the direction close to the photosensitive drum 22 to the first position, and the developing roller contacts the photosensitive drum 22, so that the developing operation can be performed.

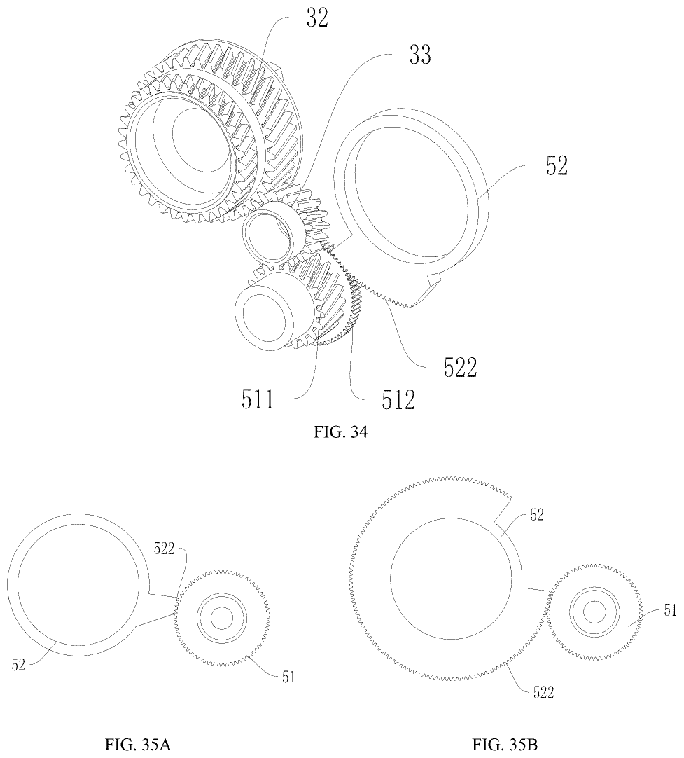

FIG. 35A is a cooperation diagram of the gear part of the first rotating member when the angle is the smallest and the transmission member of the processing cartridge, and FIG. 35B is a cooperation diagram of the gear part of the first rotating member when the angle is the largest and the transmission member of the processing cartridge. As shown in FIG. 34, FIG. 35A and FIG. 35B, the movement between the first rotating member 52 and the transmission member 51 causes the developing roller to delay contact with the photosensitive drum 22. The size of the gear part 522 of the first rotating member 52 is related to the length of the delay. The size of the gear part 522 of the first rotating member 52 is determined by an angle covered by the gear part 522 with the rotation center as the center of the circle. The corresponding central angle of the gear part 522 has an angle range of 10° to 300°. When the angle corresponding to the gear part 522 is 10°, the number of teeth corresponding to the gear part 522 is 4. When the angle corresponding to the gear part 522 is 300°, the number of teeth corresponding to the gear part 522 is 125. The following formula uses sector teeth to replace the gear part 522 for descriptive purposes. The delay time is obtained by the angle of the gear part 522, which requires the following calculations:

Assume the number of revolutions of the developing driving connector is N_{Driving}, the time is T₁, and the angular velocity is ω_{Driving}. Since the developing driving connector engages with the developing coupling and rotates synchronously, the number of revolutions of the developing coupling is also N_{Driving}, the time is T₁, and the angular velocity is ω_{Driving}.

The three elements satisfy the relationship:

$${T}_{1} = \frac{{N}_{Driving}}{{ω}_{Driving}} .$$

It is known that the number of teeth of the developing coupling is Z_{Driving} and the number of teeth of the developing roller gear is Z_{Developing}.

The number of teeth of the third gear 511 of the transmission member 51 is Z_{First}, and the number of teeth of the fourth gear 512 is Z_{Second}, the number of complete teeth of the sector teeth is Z_{Sector}, the number of teeth with the lowest delay is

$${Z}_{Sector min} = \frac{1}{36} {Z}_{Sector} ,$$

and the number of teeth with the largest delay is

$${Z}_{Sector max} = \frac{5}{6} {Z}_{Sector} .$$

Since the transmission ratio equals the ratio of the angular velocity of the driving gear to the angular velocity of the driven gear and equals the ratio of the number of teeth of the driven gear to the number of teeth of the driving gear, the formula is

$$\frac{{Z}_{1}}{{Z}_{2}} = \frac{{n}_{2}}{{n}_{1}} = \frac{{ω}_{2}}{{ω}_{1}} .$$

Assume that the transmission ratio of the developing coupling gear to the sector gear (the first rotating member 51) is α.

If the sector teeth are intact, the sector teeth will rotate N_{Sector} cycles when the developing coupling rotates one cycle.

$${N}_{Sector} = \frac{{Z}_{Second}}{{Z}_{Sector}} \times {N}_{Developing} = \frac{{Z}_{Frist}}{{Z}_{Sector}} \times \frac{{Z}_{Developing}}{{Z}_{First}} \times {N}_{Sector} = \frac{{Z}_{Second}}{{Z}_{Sector}} \times \frac{{Z}_{Developing}}{{Z}_{First}} \times \frac{{Z}_{Driving}}{{Z}_{Developing}} \times {N}_{Driving} = α {N}_{Driving}$$

Therefore, ω_{Sector}=αω_{Driving}.

If the sector teeth has the lowest delay, the number of cycles that the sector teeth contacts the transmission member is:

$${N}_{Sector min} = {N}_{Sector} \times \frac{{Z}_{Sector min}}{{Z}_{Sector}} = \frac{1}{36} α {N}_{Driving}$$

Then, the contact time is:

$${T}_{Sector min} = \frac{{N}_{Sector min}}{{ω}_{Sector}} = ( \frac{1}{36} α {N}_{Driving} ) \div {αω}_{Driving} = \frac{1}{36} \times \frac{{N}_{Driving}}{{ω}_{Driving}} = \frac{{T}_{1}}{36}$$

If the sector teeth have the highest delay, the number of cycles that the sector teeth contact the transmission element is:

$${N}_{Sector max} = {N}_{Sector} \times \frac{{Z}_{Sector max}}{{Z}_{Sector}} = \frac{5}{6} α {N}_{Driving}$$

Then, the contact time is:

$${T}_{Sector max} = \frac{{N}_{Sector max}}{{ω}_{Sector}} = ( \frac{5}{6} α {N}_{Driving} ) \div {αω}_{Driving} = \frac{5}{6} \times \frac{{N}_{Driving}}{{ω}_{Driving}} = \frac{5}{6} {T}_{1}$$

So the delay time is:

$$\frac{{T}_{1}}{36} \leq {T}_{Delay} \leq \frac{5}{6} {T}_{1}$$

That is, the delayed contact time between the developing roller and the photosensitive drum 22 is between

$$\frac{{T}_{1}}{36} \leq {T}_{Delay} \leq \frac{5}{6} {T}_{1} .$$

The developing roller and the photosensitive drum 22 are delayed for a period of time before contacting, which can ensure that the developing roller 16 and the photosensitive drum 22 are in contact only after they are fully rotated, thereby ensuring developing quality.

The other structures of the processing cartridge of Embodiment 4 are the same as those of Embodiment 1 and will not be described again in detail here.

### Embodiment 5

Embodiment 5 of the present disclosure provides another processing cartridge, which is different from Embodiment 2 in that the structure of the delay mechanism is different.

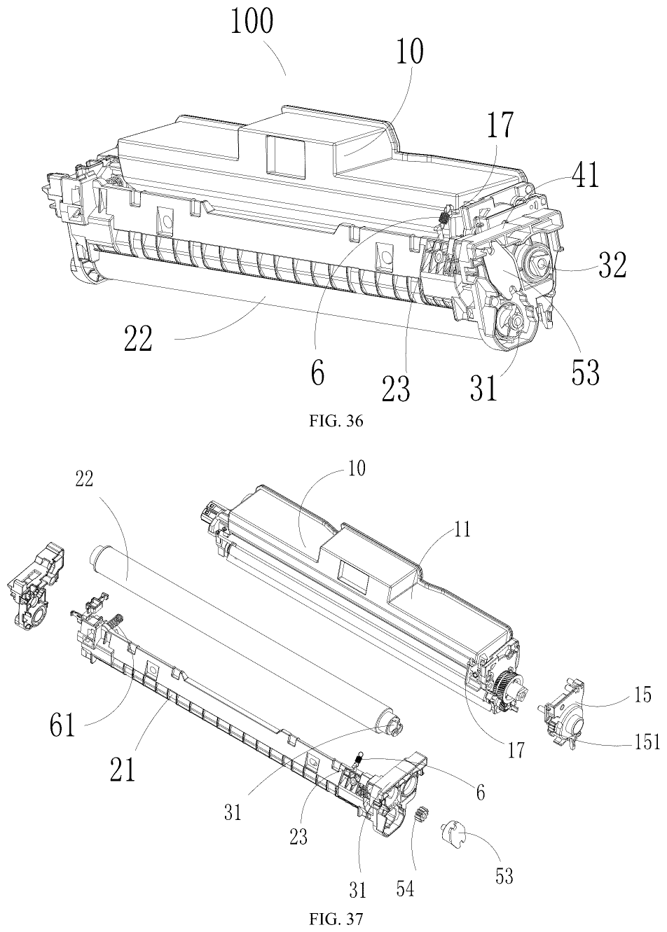

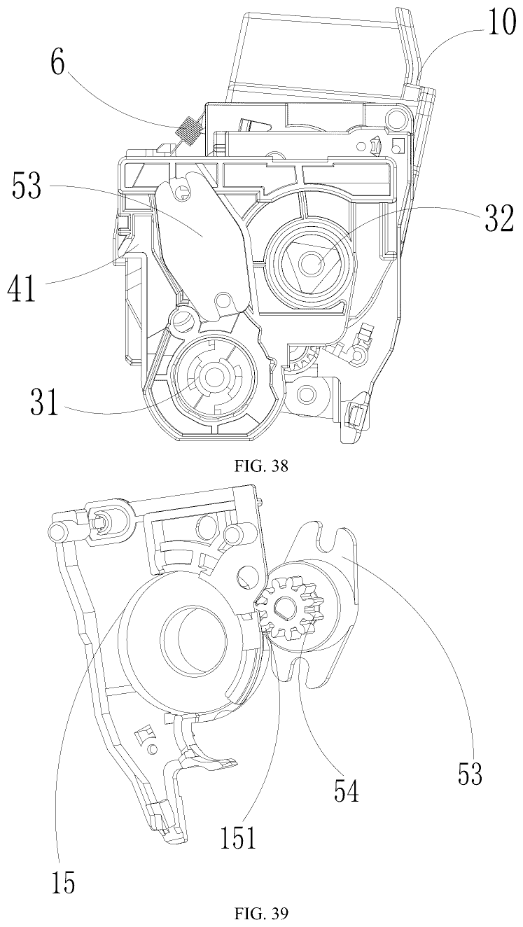

As shown in FIG. 36 to FIG. 39, the processing cartridge 100 also has a delay mechanism, which includes a delay component 53 and a delay gear 54. Specifically, a mounting part is configured on a driving side end cover 41, and the delay gear 54 is rotatably disposed on the mounting part. The delay gear 54 and the delay component 53 are coaxially configured, and the delay gear 54 can rotate relative to the delay component 53. The delay component 53 has a rotation resistance object or material inside, so that when the delay gear 54 rotates along a first rotation direction relative to the delay component 53, it will generate resistance along a second rotation direction (opposite to the first rotation direction), while the delay gear 54 will not generate resistance when rotating along the second rotation direction in the delay component 53.

The developing box cover 15 has connecting teeth 151, which are connected to the delay gear 54 to transmit force to the delay gear 54. The connecting teeth 151 are a plurality of teeth configured on the side wall of the developing box cover 15 facing the photosensitive unit 20.

When the front door of the image-forming device is closed, the upper ends of the developing unit 10 and the photosensitive unit 20 are connected together by the separating elastic member 6, while the developing roller 16 and the photosensitive drum 22 near the lower ends are in a separated state.

When the image-forming device receives an operating instruction, the force in the image-forming device is transmitted to the processing cartridge 100, the developing coupling 32 starts to rotate, and the developing unit 10 rotates clockwise along the axis of the developing coupling 32 (the lower end of the developing unit 20 moves along a direction toward the photosensitive drum 22). Since the rotational force generated by the rotation of the developing coupling 32 is greater than the elastic force of the separating elastic member 6, the separating elastic member 6 is stretched, and the first elastic member 61 changes from a first compressed state M1 to a second compressed state M2. The developing unit 10 drives the developing box cover 15 to rotate. When the developing box cover 15 rotates clockwise, the rotational force is transmitted through the connecting teeth 151. When the developing unit 10 contacts the developing roller 16, the developing roller 16 contacts the photosensitive drum 22 after a certain time of delay by the delay component 53. Since the developing coupling 32 is always rotating when the image-forming device is in operation, the rotational force generated by it always exists, and the photosensitive drum 22 and the developing roller 16 can always maintain a contact state.

When the image-forming device stops operating, the driving force transmitted to the processing cartridge 100 stops at the same time, and the developing coupling 32 stops rotating. At this moment, the separating elastic member 6 begins to contract under the action of the elastic force, and drives the developing unit 10 to rotate counterclockwise through a second hook part 17. The connecting teeth 151 on the developing box cover 15 drive the delay gear 54 to rotate in the delay component 53 along the second rotation direction. Since the delay gear 54 does not generate resistance when rotating in the delay component 53 along the second rotation direction, the separation of the photosensitive drum 22 and the developing roller 16 is synchronized with the contraction of the separating elastic member 6. When the separating elastic member 6 contracts to the normal state, at this moment, the first elastic member 61 switches from the second compressed state M2 to the first compressed state M1, and the photosensitive drum 22 is separated from the developing roller 16, and under the action of the separating elastic member 6, it can maintain the separated state. It should be noted that if damping oil is configured in the delay component 53 to delay the delay gear 54, the separation process of the processing cartridge 100 will also be delayed.

By configuring a delay mechanism and an elastic separating mechanism on the processing cartridge 100, the delayed contact and rapid separation of the developing roller 16 and the photosensitive drum 22 are implemented through the separation spring, thereby realizing the developing operation of the processing cartridge 100 in the image-forming device. The structure is simple and easy to implement and can ensure the printing quality.

The other structures of the processing cartridge of Embodiment 5 are the same as those of Embodiment 1 and will not be described again in detail here.

### Embodiment 6

Embodiment 6 of the present disclosure provides another processing cartridge. Compared with Embodiment 4, the difference is that the structure of the photosensitive coupling assembly is different and the structure of the delay mechanism is different.

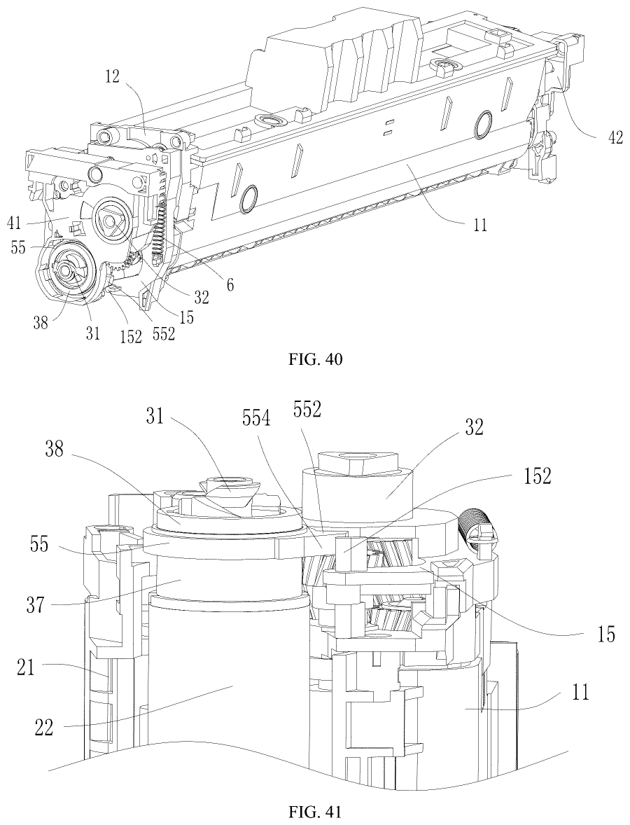

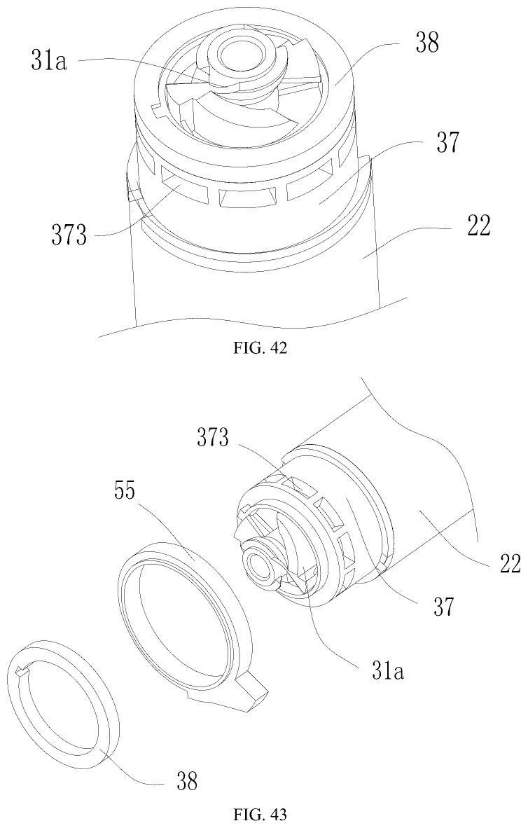

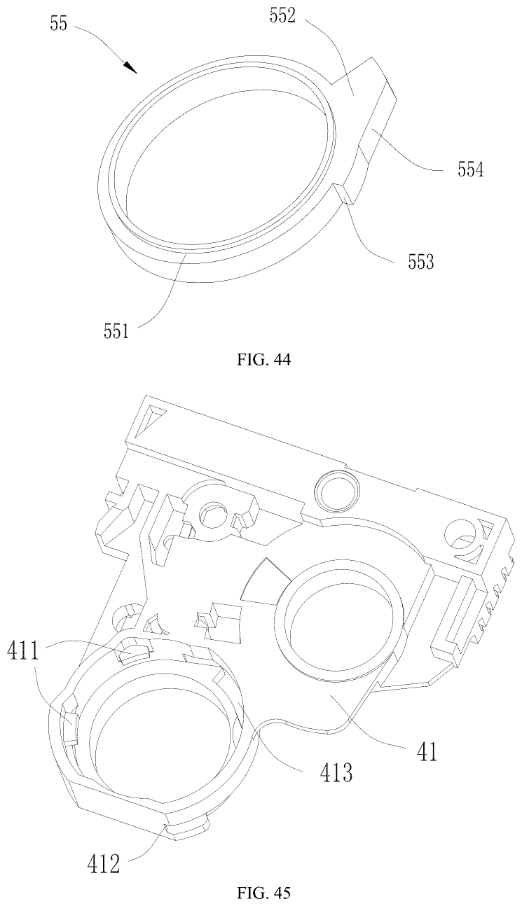

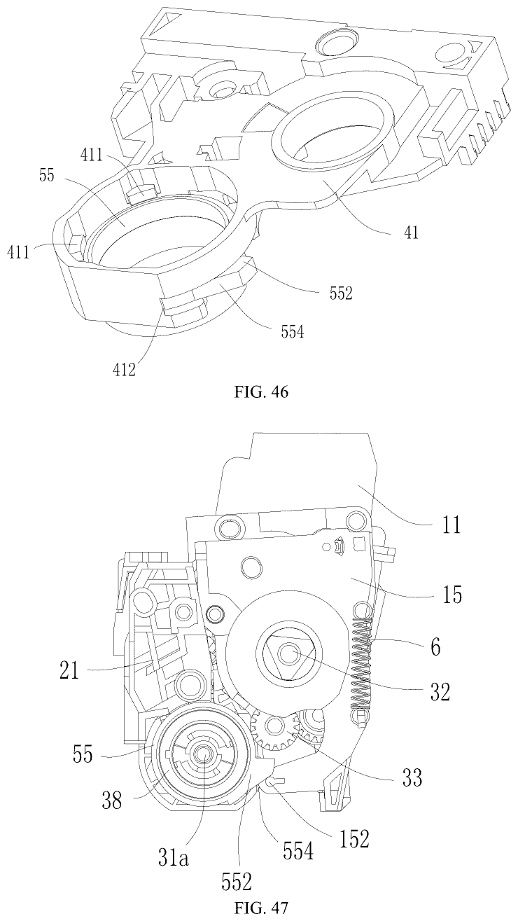

As shown in FIG. 40, FIG. 41, FIG. 43, FIG. 44 and FIG. 46, the processing cartridge includes a delay mechanism, which includes a second rotating member 55 and a first abutting part 152. The second rotating member 55 is configured on the photosensitive unit 20 and can be driven by the developing unit 10 to rotate. Specifically, a slot part is configured on the driving side end cover 41, and the slot part is configured around a first through hole. The second rotating member 55 is configured in the slot part. A positioning part 411 is configured on the inner wall of the slot part. The positioning part 411 may be one or more protrusions. The positioning part 411 abuts against the end of the second rotating member 55 away from the photosensitive frame 21, thereby limiting the axial movement of the second rotating member 55 and preventing the second rotating member 55 from coming out from the slot part. The second rotating member 55 includes a ring part 551 and a protrusion 552 configured on the circumferential surface of the ring part 551, and the ring part 551 is sleeved on the sleeve 37. Part of the sleeve 37 that is sleeved by the ring part 551 is configured with an accommodating chamber 373, which is a slot opened on the circumferential outer surface of the sleeve 37. The accommodating chamber 373 may be provided in plurality, and the plurality of accommodating chambers 373 are configured along the circumference of the sleeve 37. The accommodating chamber 373 may also be an annular slot surrounding the sleeve 37. The accommodating chamber 373 contains damping oil, and the ring part 551 is tightly adhered to the circumferential outer surface of the sleeve 37, thereby sealing the accommodating chamber 373 to prevent leakage of the damping oil.

As shown in FIG. 43 to FIG. 46, the protrusion 552 of the second rotating member 55 is roughly trapezoidal and protrudes outward from the circumferential surface of the ring part 551. A section of an opening 413 that is circumferentially extending is configured on the slot wall of the slot part of the driving side end cover 41, and the opening 413 is located on the side of the slot part close to the developing unit 10. The protrusion 552 of the second rotating member 55 extends into the opening 413 and is exposed through the opening 413. The arc length corresponding to the opening 413 is greater than the arc length corresponding to the protrusion 552. The protrusion 552 can rotate within the arc length range of the opening 413. A rotation-stopping surface 553 is configured at one end of the protrusion 552 in the circumferential direction, and the opening 413 is configured with a stopper 412 at one end in the circumferential direction. When the rotation-stopping surface 553 abuts against the stopper 412, the second rotating member 55 cannot rotate in the clockwise direction. The position where the rotation-stopping surface 553 abuts against the stopper 412 is also the initial position of the second rotating member 55. When the second rotating member 55 is in the initial position, when the drum driving connector drives the sleeve 37 to rotate, the second rotating member 55 is stationary relative to the sleeve 37, and the damping oil in the accommodating chamber 373 of the sleeve 37 exerts a force (friction) on the second rotating member 55. The protrusion 552 is also configured with an abutting inclined surface 554, which is located on the side of the protrusion 552 away from the ring part 551, and the abutting inclined surface 554 extends substantially along the tangent direction of the ring part 551.

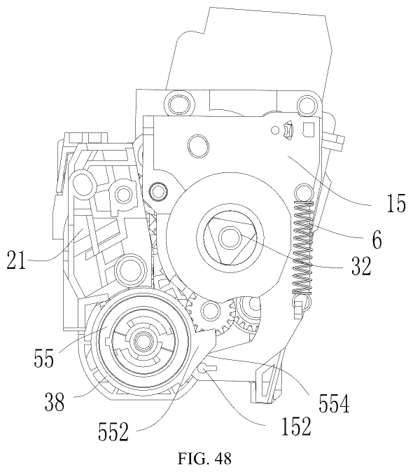

As shown in FIG. 40, FIG. 41, FIG. 47 and FIG. 48, a first abutting part 152 is configured near the lower end of the developing box cover 15, and the first abutting part 152 protrudes from the surface of the developing box cover 15 facing away from the driving side bearing 12.

As shown in FIG. 47, before the processing cartridge receives the force (driving force) of the image-forming device, the processing cartridge is in an initial state, the developing unit 10 is maintained in the separated position under the force of the separating elastic member 6, and the developing roller is separated from the photosensitive drum 22. At this moment, the second rotating member 55 is in the initial position where the rotation-stopping surface 553 abuts against the stopper 412, and the first abutting part 152 abuts against the end of the abutment inclined surface 554 away from the rotation-stopping surface 553.

As shown in FIG. 47 and FIG. 48, when a developing operation is required, the driving member of the drum driving connector of the image-forming device engages with the engaging part 31a, and the end surface of the shell of the drum driving connector abuts against the friction component 38 and compresses the friction component 38. When the drum driving connector rotates, it generates a large friction with the friction component 38 to transmit the driving force to the photosensitive drum through the sleeve 37, and the photosensitive drum starts to rotate. The second rotating member 55 abuts against the stopper 412 due to the rotation-stopping surface 553, and does not rotate with the sleeve 37. At the same time, the developing driving connector of the image-forming device engages with the developing coupling 32 of the developing unit 10, and the developing coupling 32 receives the driving force and starts to rotate. Due to the large torque of the driving force and the friction (when the developing driving connector is engaged with the developing coupling 32, part of the developing driving connector will contact the developing box cover 15, and friction will be generated between the two when the developing driving connector rotates), a force (this force can overcome the force of the separating elastic member 6) can be generated to move the developing unit 10 from a second position to a first position. That is, the lower end of the developing unit 10 moves toward the lower end of the photosensitive unit 20, and the first abutting part 152 moves with the developing unit 10 toward the photosensitive unit 20. The first abutting part 152 slides relatively along the abutting inclined surface 554, exerting a force on the abutting inclined surface 554, and driving the second rotating member 55 to rotate counterclockwise until the lower end of the developing unit 10 continues to move toward the photosensitive drum 22 to the contact position. The developing roller contacts the photosensitive drum 22, and the processing cartridge starts the developing operation. By configuring a delay mechanism, the developing unit 10 can continue to move to the contact position only after the second rotating member 55 rotates a certain angle, which prolongs the time it takes to move to the contact position and delays the time point when the developing roller 16 contacts the photosensitive drum 22, so that the two contact only after they are fully rotated, preventing developing defects and improving the developing quality.

As shown in FIG. 47 and FIG. 48, when the image-forming device finishes the developing operation, the developing driving connector of the image-forming device stops rotating. Since the developing driving connector stops rotating, the developing driving force disappears, and the force of the separating elastic member 6 on the developing unit 10 drives the developing unit 10 to rotate in a direction away from the photosensitive drum 22 to the separated position, and the developing roller is separated from the photosensitive drum 22. At the same time, the first abutting part 152 moves with the developing unit 10 away from the second rotating member 55, and the force on the second rotating member 55 disappears. Since the second rotating member 55 is sleeved on the sleeve 37, under the action of the friction between the damping oil in the accommodating chamber 373 of the sleeve 37 and the second rotating member 55, the second rotating member 55 rotates clockwise to the initial position where the rotation-stopping surface 553 abuts against the stopper 412 of the driving side end cover 41. Then, the drum driving connector stops rotating, and the photosensitive coupling assembly and the photosensitive drum 22 also stop rotating.

In some embodiments, the second rotating member 55 may be restored to its initial position by configuring a separating elastic member. The separating elastic member is disposed between the second rotating member 55 and the driving side end cover 41. When the second rotating member 55 is driven by the first abutting part 152 to rotate counterclockwise, the separating elastic member is deformed. When the developing is finished, the restoration of the elastically deformed separating elastic member 6 makes the second rotating member 55 rotate clockwise to return to its initial position.

The other structures of the processing cartridge of Embodiment 6 are the same as those of Embodiment 1 and will not be described again in detail here.

### Embodiment 7

Embodiment 7 of the present disclosure provides another processing cartridge, which is different from Embodiment 6 in that the structure of the delay mechanism is different.

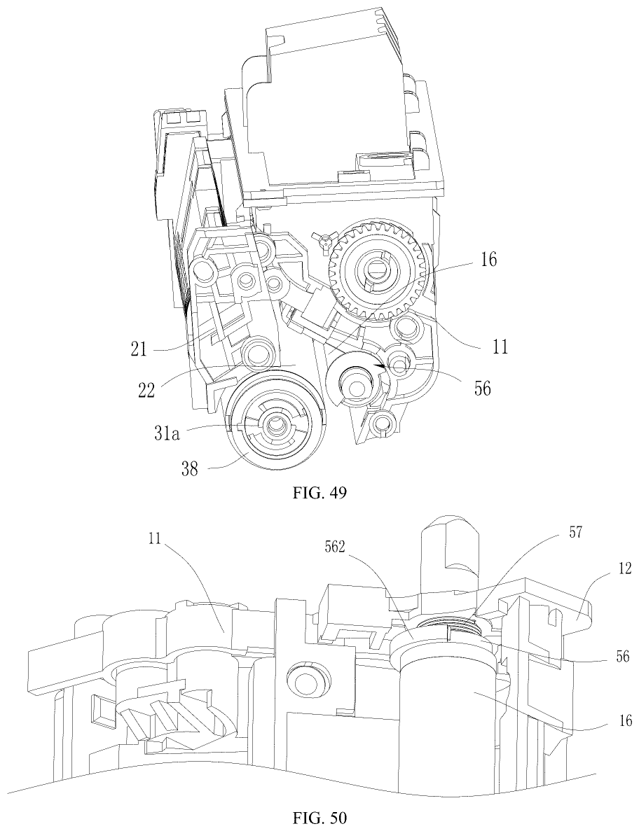

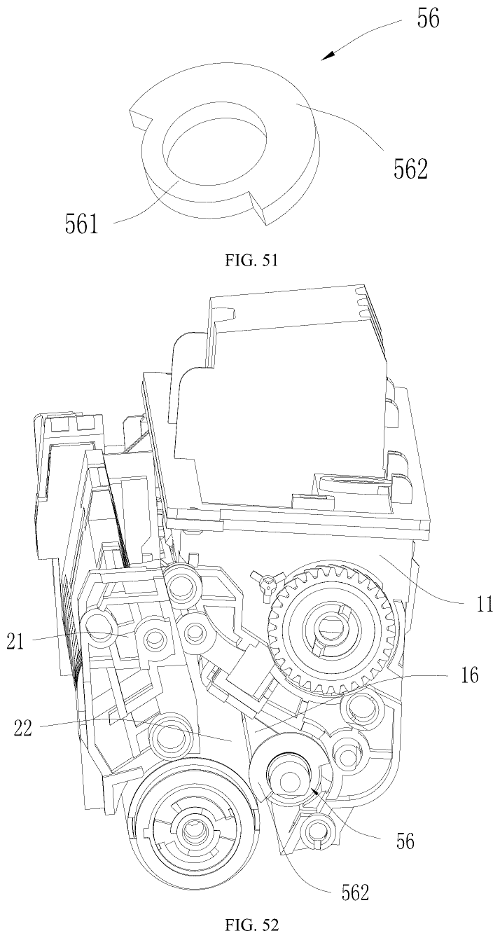

In the disclosed embodiment, as shown in FIG. 49 and FIG. 51, the delay mechanism includes a third rotating member 56. The third rotating member 56 includes a fixed part 561 and a second abutting part 562, the fixed part 561 has a circular ring structure, and the fixed part 561 is sleeved on an end of the developing roller shaft of the developing roller 16. The third rotating member 56 is located on the inner side of the driving side bearing 12, the inner diameter of the fixed part 561 is slightly larger than the diameter of the developing roller shaft of the developing roller 16, and can reduce the friction between the third rotating member 56 and the shaft of the developing roller 16 when the two rotate relative to each other.

The second abutting part 562 is a circular sector and has a diameter greater than the diameter of the roller body of the developing roller 16. The diameter of the second abutting part 562 is also greater than the diameter of the fixed part 561. When the second abutting part 562 abuts against the surface of the photosensitive drum 22, the roller body of the developing roller 16 does not contact the photosensitive drum 22. When the second abutting part 562 contacts the photosensitive drum 22, it can be driven by the rotating photosensitive drum to rotate.

As shown in FIG. 50, the processing cartridge also includes a reset member 57, which is used to restore the third rotating member 56 to a position where the second abutting part 562 can contact the photosensitive drum, that is, the initial position of the third rotating member 56. When the third rotating member 56 is in the initial position, the second abutting part 562 faces the photosensitive drum. Specifically, the reset member 57 is a torsion spring, which is sleeved on one end of the shaft of the developing roller 16 and is located outside the third rotating member 56 (that is, the torsion spring is located between the driving side bearing 12 and the third rotating member 56), one end of the torsion spring abuts against the third rotating member 56, and the other end is fixed to the driving side bearing 12.

As shown in FIG. 49, when the processing cartridge is placed in place in the image-forming device but does not receive a driving force, the developing unit 10 of the processing cartridge is in a separated position, the developing roller 16 is separated from the photosensitive drum 22, and the second abutting part 562 of the third rotating member 56 does not contact the photosensitive drum.

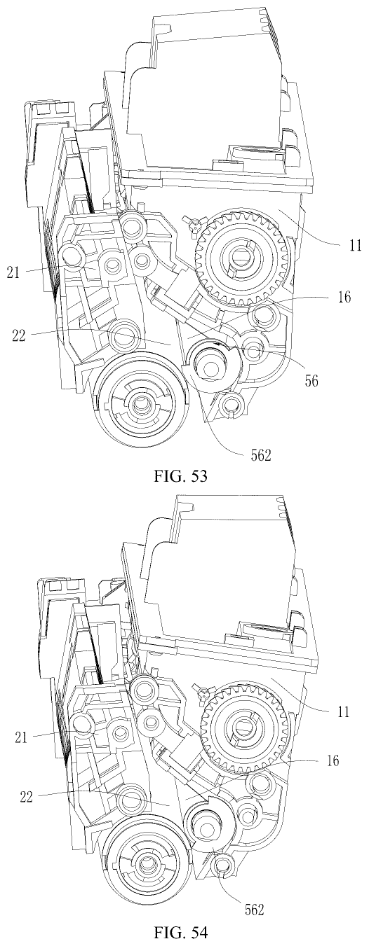

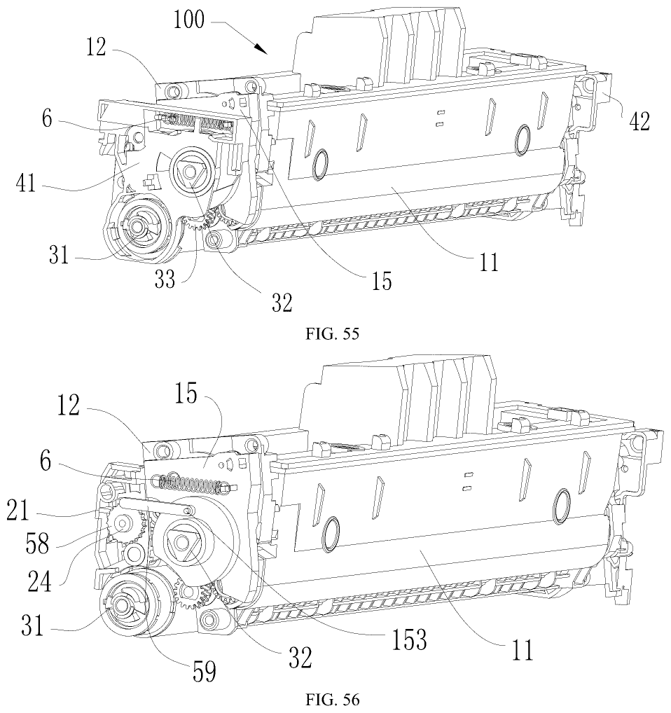

As shown in FIG. 52 to FIG. 54, when a developing operation is required, the drum driving connector of the image-forming device drives the photosensitive drum to start rotating. At the same time, the developing driving connector of the image-forming device engages with the developing coupling 32 of the developing unit 10, and the developing coupling 32 receives the driving force and starts to rotate. Due to the large torque of the driving force and the friction (when the developing driving connector is engaged with the developing coupling 32, part of the developing driving connector will contact the developing box cover 15, and friction will be generated between the two when the developing driving connector rotates), a force (this force can overcome the force of a separating elastic member 6) can be generated to move the developing unit 10 from the separated position to the contact position, that is, the lower end of the developing unit 10 moves closer to the developing unit 10. The developing unit 10 moves toward the lower end of the photosensitive unit 20, the third rotating member 56 follows the developing unit 10 to move toward the photosensitive unit 20, and the second abutting part 562 abuts against the surface of the photosensitive drum 22. At this moment, the developing roller 16 has not yet contacted the photosensitive drum. As the photosensitive drum 22 rotates, the third rotating member 56 abutting therewith is driven to rotate, and the third rotating member 56 rotates to make the reset member 57 deform. When the photosensitive drum 22 drives the third rotating member 56 to rotate until the second abutting part 562 is out of abutment with the surface of the photosensitive drum 22, the developing unit 10 continues to move toward the photosensitive drum 22 to the contact position under the action of torque and friction, the developing roller 16 contacts the photosensitive drum 22, and the processing cartridge starts developing.

As shown in FIG. 49 and FIG. 52 to FIG. 54, when the image-forming device finishes the developing operation, the developing driving connector of the image-forming device stops rotating. Since the developing driving connector stops rotating, the developing driving force disappears, and the force of the separating elastic member 6 on the developing unit 10 drives the developing unit 10 to rotate in a direction away from the photosensitive drum 22 to the separated position, and the developing roller 16 is separated from the photosensitive drum 22. At the same time, the third rotating member 56 is restored to the initial position under the action of the elastic restoration force of the reset member 57, after which the drum driving connector stops rotating, and the photosensitive coupling assembly and the photosensitive drum 22 also stop rotating.

It should be noted that the third rotating member 56 of the disclosed embodiment may be configured at one end or both ends of the developing roller shaft of the developing roller 16.

The other structures of the processing cartridge of Embodiment 7 are the same as those of Embodiment 1 and will not be described again in detail here.

### Embodiment 8

Embodiment 8 of the present disclosure provides another processing cartridge, which is different from the previous embodiments in that the structure of the delay mechanism is different.

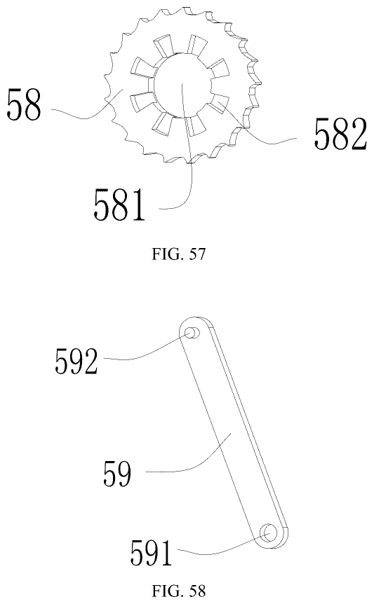

As shown in FIG. 56 to FIG. 58, in the disclosed embodiment, the delay mechanism includes a ratchet wheel 58 and a connecting rod 59, one end of the connecting rod 59 is rotatably connected to the developing box cover 15, and the other end contacts a gear part of the ratchet wheel 58. The connecting rod 59 is configured to receive the force of the developing box cover 15 to move, thereby driving the ratchet wheel 58 to move. Specifically, a through hole 591 is configured at one end of the connecting rod 59 for connecting with a connecting part 153 on the developing box cover 15, and the connecting part 153 protrudes axially away from the developing frame 11. The other end of the connecting rod 59 is configured with a shaft part 592, which abuts against the gear part of the ratchet wheel 58. Optionally, the connecting part may also be configured as a hole, and a protrusion may be configured at one end of the connecting rod 59 to connect with the hole, which can also realize the rotatable connection between the connecting rod 59 and the developing box cover 15

Further, as shown in FIG. 56, the photosensitive frame 21 is configured with a cylindrical boss 24 on the end surface of the driving side, the ratchet wheel 58 is rotatably sleeved on the cylindrical boss 24 through a center hole 581, and the inner side surface of the ratchet wheel 58 (the side facing the cylindrical boss 24) is configured with one or more receiving slots 582. Damping material (preferably damping oil) is stored in the receiving slot 582, which can provide stable rotational damping, and a plurality of receiving slots 582 are configured in an annular array at intervals on the periphery of the center hole 581. When the connecting rod 59 is subjected to the force of the developing box cover 15 and starts to rotate, the connecting rod 59 drives the ratchet wheel 58 to rotate synchronously, and the damping oil in the receiving slot 582 contacts the cylindrical boss 24 to generate rotational damping, so that the ratchet wheel 58 rotates relatively smoothly and slowly.

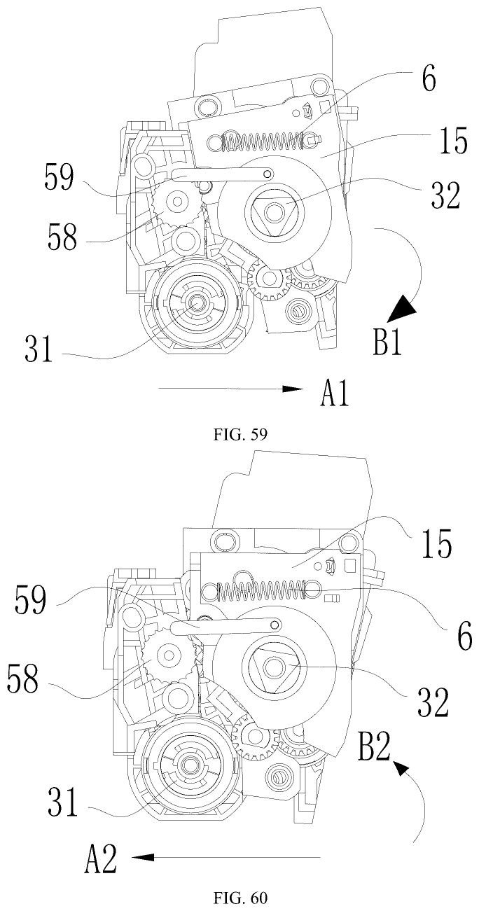

As shown in FIG. 59, in the disclosed embodiment, when the developing coupling 32 engages with the developing driving connector of the image-forming device and receives the driving force, since the torque of the driving force and the force of the developing unit's own weight are much greater than the force of the separating elastic member 6 on the developing unit, the entire developing unit rotates around the rotation center to the contact position, so that the photosensitive drum contacts the developing roller, thereby enabling the developing operation. Specifically, when the developing driving connector starts to rotate, the developing unit starts to rotate in a first swing direction B1 under the action of the torque (the first swing direction B1 is the clockwise direction when viewed from the angle of FIG. 59). At the same time, because one end of the connecting rod 59 is connected to the developing box cover 15 and the other end contacts the gear part of the ratchet wheel 58, when the entire developing unit swings around the rotation center in the first swing direction B1, one end of the connecting rod 59 is driven to swing around the connecting part 153 of the developing box cover 15. That is, the connecting rod 59 is driven to move in the A1 direction, and the other end of the connecting rod 59 is dragged downward against the gear of the ratchet wheel 58 by its own weight through a protrusion. When the connecting rod 59 moves in the A1 direction, it also drives the ratchet wheel 58 to rotate clockwise. Because there is damping fluid in the ratchet wheel 58, when it is acted upon by the force of the connecting rod 59, the ratchet wheel 58 can be made to slowly rotate in the A1 direction to the next gear part, thereby making the entire developing unit to slowly rotate around the rotation center to the contact position, making the photosensitive drum contact the developing roller, and starting the developing operation.

As shown in FIG. 60, when the image-forming device finishes the developing operation, the developing driving connector of the image-forming device stops rotating, and the torque of the driving force disappears. The force of the separating elastic member 6 on the developing unit is greater than the force of the developing unit's own weight, so that the lower end of the developing unit rotates in a direction away from the photosensitive drum under the force of the separating elastic member 6, so that the processing cartridge returns to the state where the developing roller is separated from the photosensitive drum. Specifically, when the developing driving connector stops rotating, the entire developing unit swings along a second swing direction B2 (viewed from the angle of FIG. 60, the second swing direction B2 is counterclockwise). At the same time, the connecting rod 59 moves in the A2 direction (opposite to the A1 direction) under the control of the developing box cover 15, so that the entire ratchet wheel 58 rotates counterclockwise under the force of the connecting rod 59 moving in the A2 direction, and slowly rotates in the A2 direction to the next gear part, and the ratchet wheel 58 is reset to wait for the next drum roller contact.

The separating elastic member 6, connecting rod 59 and ratchet wheel 58 configured in the processing cartridge of the disclosed embodiment can realize the separation of the developing roller and the photosensitive drum when the image-forming device is not in operation. Therefore, it solves the technical problem in the existing technology of long-term contact between the photosensitive drum and the developing roller 16, which causes the deposition of colorant on the photosensitive drum and therefore contaminates the photosensitive drum. It also solves the technical problem of long-term friction between the photosensitive drum and the developing roller, which accelerates the deterioration of the developing roller or the developer. In addition, the connecting rod 59 and the ratchet wheel 58 are configured at the same time to control the contact between the developing unit and the photosensitive unit to be slow. This can delay the time point when the developing roller contacts the photosensitive drum 22, and the developing roller and the photosensitive drum 22 make contact only after both the developing roller and the photosensitive drum 22 have completed their rotations, thereby avoiding the occurrence of developing defects and ensuring developing quality. The delay mechanism controls the contact between the developing unit and the photosensitive unit to be slow, and can also buffer the impact when the developing roller contacts the photosensitive drum, effectively prolonging the service life of the photosensitive drum and the developing roller.

The other structures of the processing cartridge of Embodiment 8 are the same as those of Embodiment 1 and will not be described again in detail here.

### Embodiment 9

Embodiment 9 of the present disclosure provides another processing cartridge, which is different from the previous embodiments in that the structure of the delay mechanism is different.

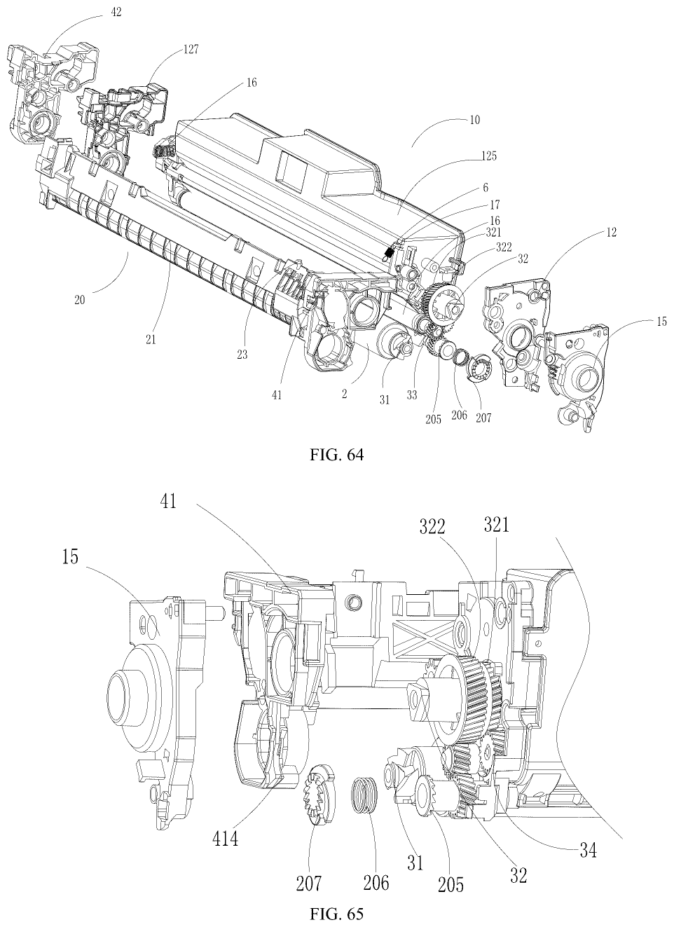

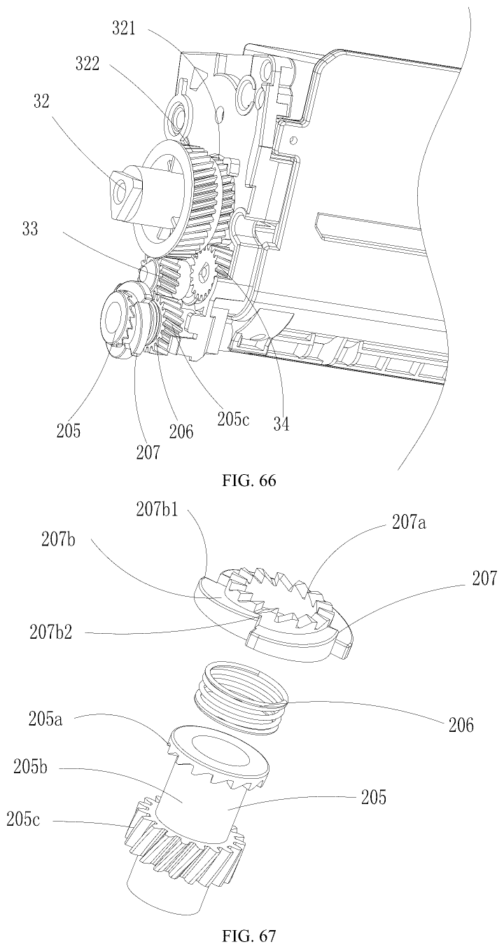

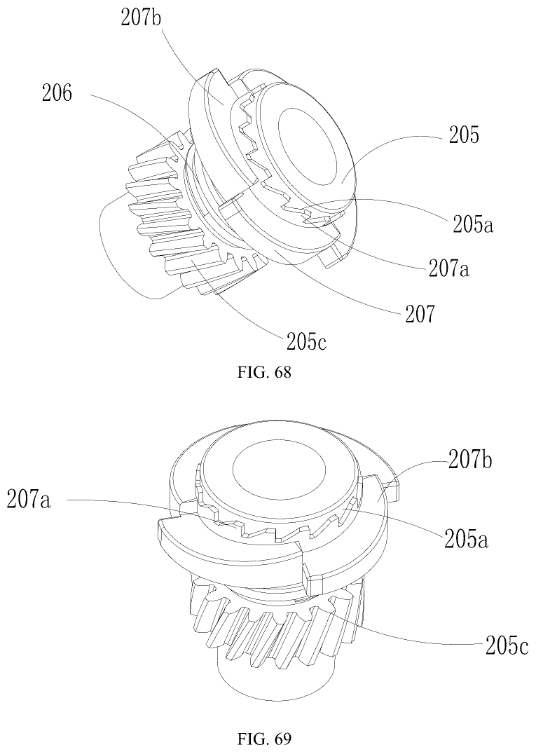

As shown in FIG. 63 to FIG. 69, the delay mechanism includes a delay gear 205, an elastic component 206 and a delay component 207, where the delay gear 205 is configured with a gear 205c, a cylindrical section 205b and a teeth part 205a in sequence along the axial direction, and the teeth part 205a is configured at an end away from the developing frame 11. The gear 205c engages with the developing roller gear 33, thereby indirectly receiving the driving force of the developing coupling 32 to rotate. The gear 205c may be integrally formed with the delay gear 205, or may be coaxially and detachably configured, and when the gear 205c is driven to rotate, the cylindrical section 205b and the teeth part 205a also rotate synchronously.

As shown in FIG. 67 to FIG. 69, the elastic component 206 and the delay component 207 are sleeved on the cylindrical section 205b of the delay gear 205, and the elastic component 206 is disposed between the gear 205c and the delay component 207. The delay component 207 can move elastically under the action of the elastic component 206. The delay component 207 is configured with a claw part 207a engaged with the teeth part 205a, the delay part 207b is also configured on its outer circumference, and the end surface of the delay part 207b away from the developing frame 11 may be an inclined surface or a spiral surface. One end of the end surface is the lowest end 207b1, and the other end opposite the lowest end 207b1 is the highest end 207b2. Relative to the claw part 207a, the lowest end 207b1 is farthest from the claw part 207a, and the highest end 207b2 is closest to the claw part 207a, that is, the distance between the end surface of the delay part 207b and the claw part 207a decreases in sequence from the lowest end 207b1 to the highest end 207b2. Here, the delay part 207b may be configured to be more than one, preferably three or four. When the claw part 207a on the delay component 207 is disengaged from the teeth part 205a on the delay gear 205, the elastic component 206 is compressed, and when engaged, the elastic component 206 is restored.

As shown in FIG. 65 and FIG. 70 to FIG. 72, the driving side end cover 41 is also configured with a third abutting part 414, which can abut against the delay part 207b on the delay mechanism and can move along the delay part 207b. That is, the third abutting part 414 can move from the lowest end 207b1 to the highest end 207b2, so that the developing roller 16 can separate from and contact with the photosensitive drum 22, and the contact process between the developing roller 16 and the photosensitive drum 22 can be delayed. The third abutting part 414 may be a protruding structure integrally or separately configured on the driving side end cover 41.

Further, at the end of the driving side, the processing cartridge 100 also has a separating elastic member 6, and the separating elastic member 6 has two pull rings, which can be hooked with the first hook part 23 on the photosensitive frame 21 and the second hook part 17 on the developing frame 11 respectively. When the photosensitive drum 22 and the developing roller 16 are in a separated state, the distance between the first hook part 23 and the second hook part 17 is relatively close, and the separating elastic member 6 is in a normal state or a compressed state. When the photosensitive drum 22 and the developing roller 16 are in a contact state, the distance between the first hook part 23 and the second hook part 17 is relatively far, and the separating elastic member 6 is in an extended state.

At the end of the non-driving side, the processing cartridge 100 also has a first elastic member 61, which is engaged with the photosensitive frame 21 and the developing frame 11. When the photosensitive drum 22 is separated from the developing roller 16, the first elastic member 61 is in a first compressed state with a compression degree of M1.

When the photosensitive drum 22 is in contact with the developing roller 16, the first elastic member 61 is still in a second compressed state M2. The first compressed state M1 has a higher compression degree than the second compressed state M2, and the first elastic member 61 is shorter in the first compressed state M1, with the benefit being that the driving side and the non-driving side of the processing cartridge 100 can be balanced.

When the image-forming device receives an operating instruction and is under a developing operation, the developing coupling 32 rotates, thereby driving the developing roller 16 and the delay mechanism to rotate together. When the operating instruction is completed, the developing operation ends, the developing coupling 32 stops rotating, and the developing roller 16 and the delay mechanism also stop rotating.

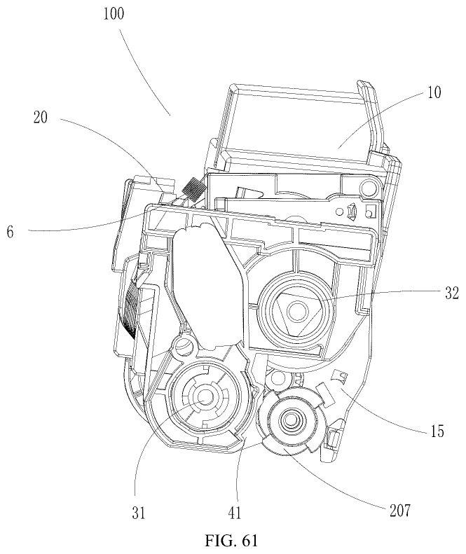

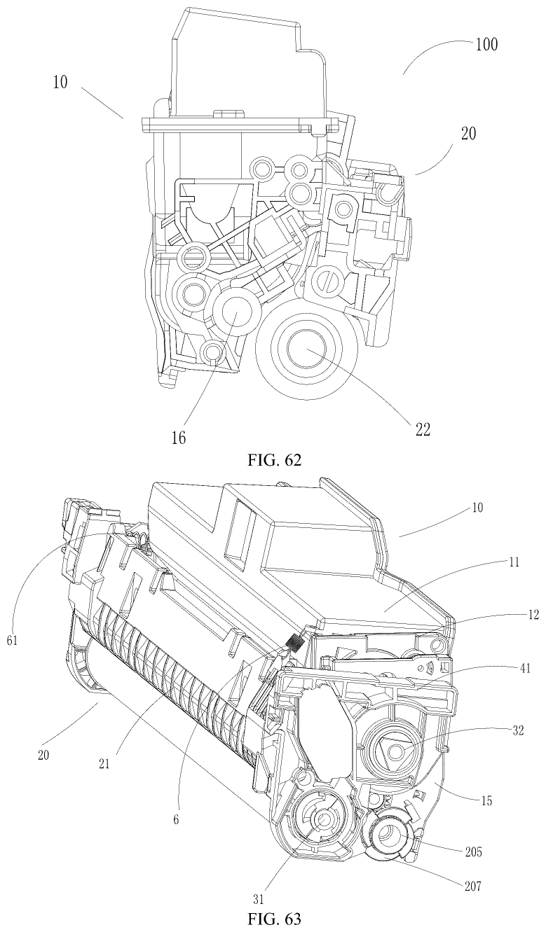

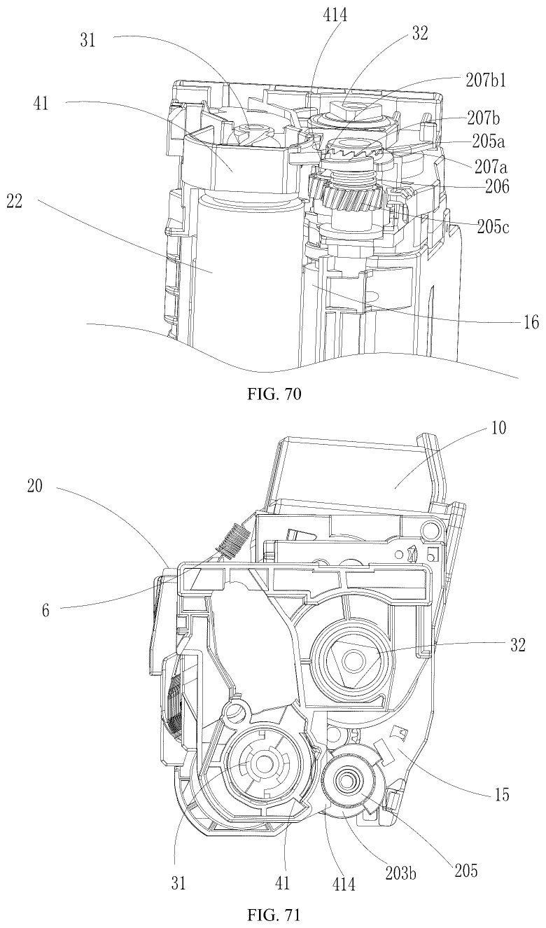

As shown in FIG. 61, FIG. 63 and FIG. 70, when the image-forming device does not receive an operating instruction, the developing coupling 32 and the developing roller 16 are in a stationary state, the developing roller gear 33 on the developing roller 16 does not rotate, the teeth part 205a of the delay mechanism is engaged with the claw part 207a, and the third abutting part 414 abuts against the lowest end 207b1 on the delay part 207b. The elastic component 206 is in a free state, and the developing roller 16 is separated from the photosensitive drum 22.

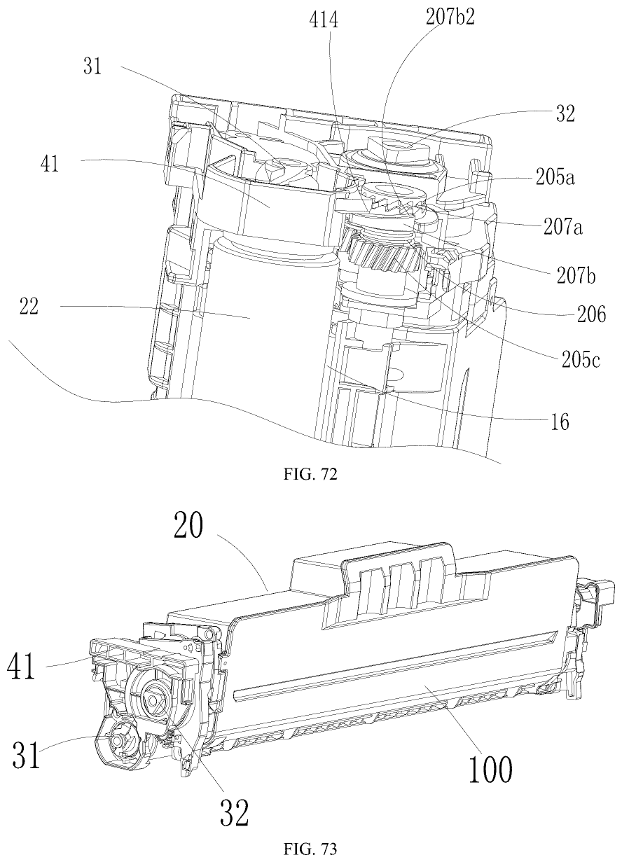

As shown in FIG. 71 and FIG. 72, when the image-forming device receives an operating instruction, the developing coupling 32 starts to rotate, and the rotational force (torque) generated by it will be greater than the tension of the separating elastic member 6, the tension spring is stretched, and the first elastic member 61 switches from the first compressed state M1 to the second compressed state M2. The first elastic member 61 is stretched, and the lower end of the developing unit 10 is tilted toward the lower end of the photosensitive unit 20, and the second-stage gear 322 and the first-stage gear 321 thereon also rotate. The second-stage gear 322 rotates while driving the developing roller gear 33 on the developing roller 16 to rotate together, thereby driving the gear 205c on the delay mechanism to rotate. When the teeth part 205a on the delay mechanism is engaged with the claw part 207a, the delay component 207 also rotates accordingly. The third abutting part 414 will move spirally upward on the delay part 207b, that is, starting from the lowest end 207b1 to the highest end 207b2. When the third abutting part 414 reaches the highest end 207b2 or near it, the delay component 207 moves toward the direction closer to the gear 205c under the abutment of the third abutting part 414, the claw part 207a is disengaged from the teeth part 205a, and the elastic component 206 is compressed. At the same time, since the farthest end of the highest end 207b2 is closest to the claw part 207a, under the action of the rotational force, the delay mechanism will move closer to the driving side end cover 41, and the lower end of the developing unit 10 will move closer to the lower end of the photosensitive unit 20 again. Then, the developing roller 16 and the photosensitive drum 22 are close to and in contact with each other, thereby realizing delayed developing and ensuring printing quality.

During the period that the third abutting part 414 moves from the lowest end 207b1 to the highest end 207b2, the developing roller 16 will not be in contact with the photosensitive drum 22, preventing the developing roller 16 from contacting the photosensitive drum 22 as soon as the developing coupling 32 starts to rotate, which will cause defects in printing quality. Therefore, the developing roller 16 will only contact the photosensitive drum 22 when the third abutting part 414 reaches the highest end 207b2 or near it.

When the image-forming device finishes operating, the developing coupling 32 stops rotating, the second-stage gear 322 and the first-stage gear 321 stop rotating, then the developing roller gear 33 on the developing roller 16 stops rotating, and the developing roller 16 stops rotating. Because the separating elastic member 6, the first elastic member 61 and the elastic component 206 are stretched and compressed during the developing process, in the absence of any driving force, the elastic forces of the separating elastic member 6, the first elastic member 61 and the elastic component 206 will be released instantly, and the upper end of the developing unit 10 move closer to the upper end of the photosensitive unit 20. Under the elastic force of the elastic component 206, the claw part 207a will move toward the teeth part 205a and engage with the teeth part 205a again, the third abutting part 414 will abut against the lowest end 207b1 on the delay component 207 again, and the developing roller 16 will separate from the photosensitive drum 22 again. When the image-forming device receives an operating instruction again, it will continue to repeat the above process.

In some embodiments, in order to prevent the delay mechanism from interfering with the interior of the image-forming device, the gear 205c on the delay mechanism may engage with the powder feeding roller gear 34. Since the powder feeding roller gear 34 engages with the first-stage gear 321, the delay mechanism will be closer to the developing frame 11 at this moment.

The other structures of the processing cartridge of Embodiment 9 are the same as those of Embodiment 1 and will not be described again in detail here.

### Embodiment 10

Embodiment 10 of the present disclosure provides another processing cartridge, which is different from the previous embodiments in that the structure of the separating mechanism is different.

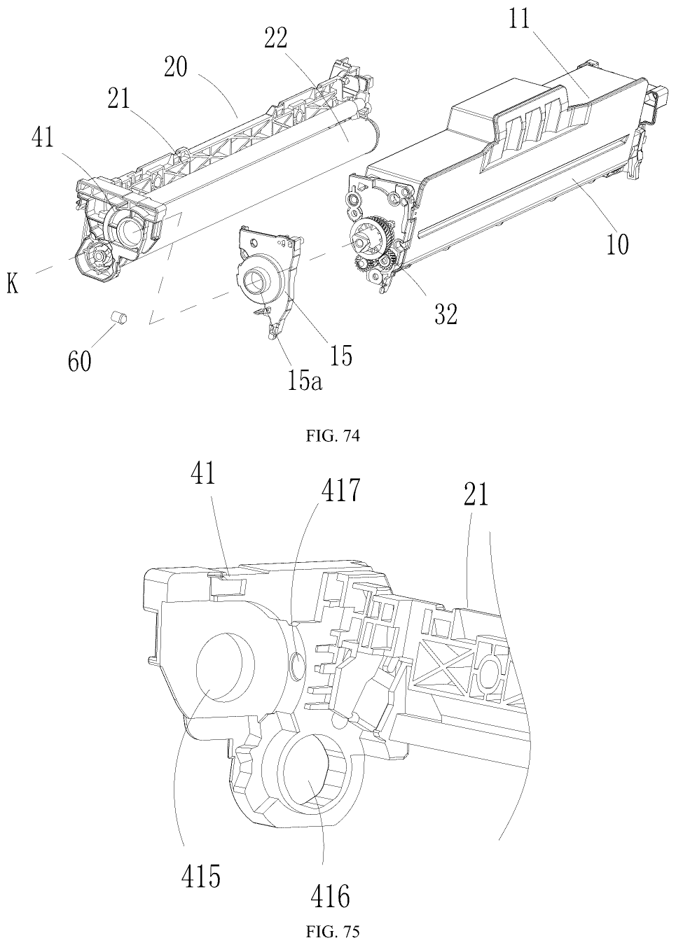

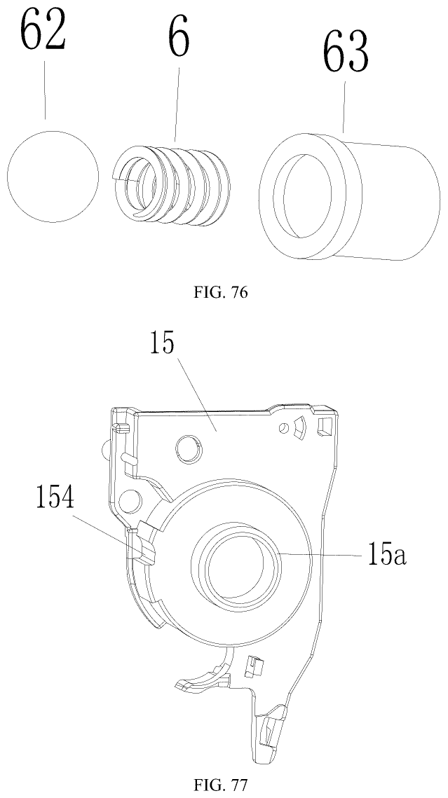

As shown in FIG. 74 to FIG. 77, the processing cartridge 100 is configured with a separating mechanism 60 to control the separation of the photosensitive drum 22 and the developing roller 16 and keep the developing roller 16 and the photosensitive drum 22 in a separated position. In addition, the developing coupling 32 receives a torque generated by the driving force of the image-forming device to move the developing frame relative to the photosensitive frame to realize the contact between the developing roller 16 and the photosensitive drum.

The processing cartridge 100 also includes a developing box cover 15, which is configured with a cylindrical part 15a, and the cylindrical part 15a is configured in a second through hole 415 of the driving side end cover 41. A first through hole 416 is configured on the driving side end cover 41 at a position adjacent to the second through hole 415, and the first through hole 416 is configured to rotatably support the photosensitive drum 22.

As shown in FIG. 75, an accommodating part 417 is configured at a position adjacent to the second through hole 415 on the driving side end cover 41. One end of the accommodating part 417 is configured with an opening, and the other end is a closed structure. The interior of the accommodating part 417 is a hollow structure, and the separating mechanism 60 is partially configured in the accommodating part 417. The separating mechanism 60 is constructed to include a separating elastic member 6 and an abutting member 62, and also includes an accommodating member 63 that can wrap the two. One end of the accommodating member 63 can enter from the opening of the accommodating part 417, and the other end of the accommodating member 63 also has an opening. One end of the abutting member 62 contacts with one end of the separating elastic member 6, and the other end of the abutting member 62 is exposed at the opening of the accommodating member 63. The other end of the separating elastic member 6 abuts against the bottom of the accommodating member 63. In the disclosed embodiment, the separating elastic member 6 adopts a spring, and the abutting member 62 adopts a spherical member. In addition, as shown in FIG. 77, the developing box cover 15 is configured with an action part 154 that cooperates with the separating mechanism 60. The action part 154 is configured on some of the circumferential surface of the cylindrical part 15a of the developing box cover 15. In the disclosed embodiment, the action part is constructed as an arc structure, which allows the abutting member 62 to enter.

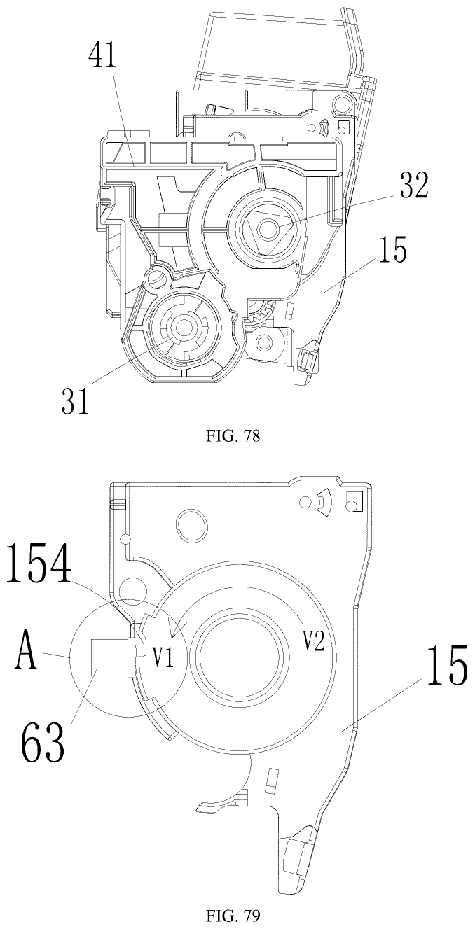

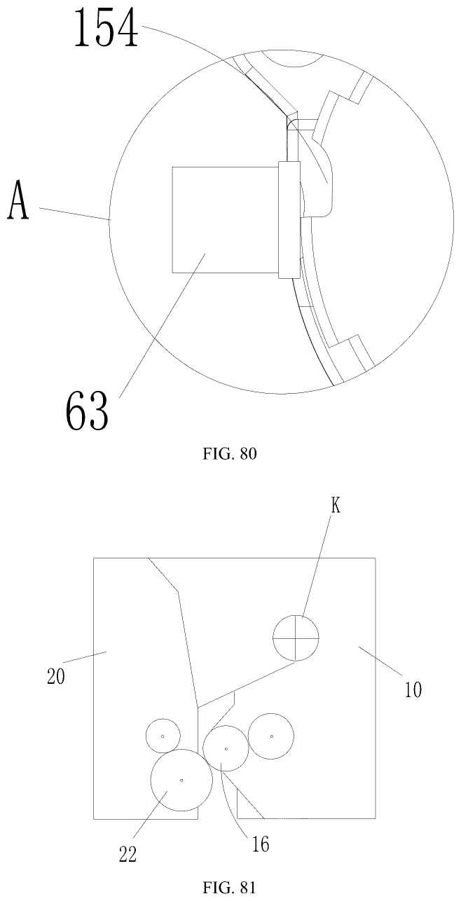

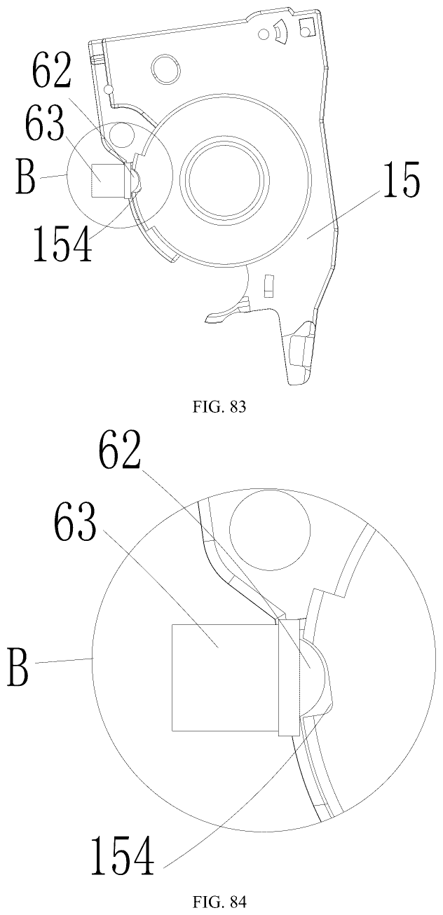

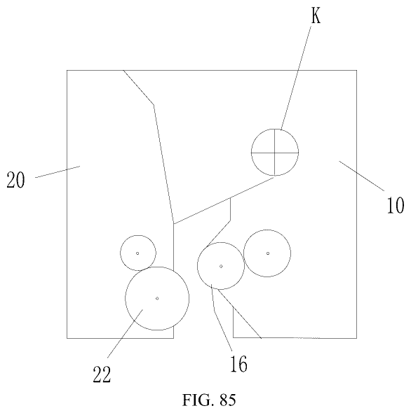

As shown in FIG. 78 to FIG. 85, the operating process of the disclosed embodiment to implement the contact or separation between the developing roller and the photosensitive drum is as follows.

The processing cartridge 100 is placed into the main assembly (tray) of the image-forming device, and the front door of the image-forming device is closed. A connecting rod mechanism (not shown in FIGs) provided in the image-forming device is released from interlocking with the door cover. The drum driving connector and the developing driving connector configured in the image-forming device extend from the side wall of the printer and are coupled with the photosensitive coupling 31 of the photosensitive drum 22 and the developing coupling 32 of the developing roller 16 respectively. At this moment, the abutting member 62 is accommodated in the action part 154.

As shown in FIG. 78 to FIG. 81, when the developing coupling 32 receives the driving force from the image-forming device and starts to rotate, the torque generated by the driving force makes the developing frame move relative to the photosensitive frame, so that the lower end of the developing frame 11 moves toward a direction close to the photosensitive frame 21, forcing the abutting member 62 in the separating mechanism 60 to disengage from the action part 154. That is, the abutting member 62 moves away from the bottom of the arc slot and stays at the upstream side position of the rotation direction of the developing box cover 15, and the abutting member 62 compresses the separating elastic member 6 while retracting into the accommodating member 63. During the entire process, the separating elastic member 6 located in the accommodating part 417 is deformed (in a compressed state), so that the developing unit 10 can rotate around its swing axis K in the V2 direction (clockwise direction) from the separated position to the contact position. That is, the developing roller 16 in the developing unit 10 moves toward the direction close to the photosensitive drum 22 in the photosensitive unit 20 until the developing roller 16 contacts the photosensitive drum 22.

It should be noted that the position of the developing unit 10 where the developing roller 16 and the photosensitive drum 22 contact each other is called the contact position (as shown in FIG. 81). The contact position (developing position) where the developing roller 16 contacts the photosensitive drum 22 is not only a position where the surface of the developing roller 16 contacts the surface of the photosensitive drum 22, but also includes a position where the toner carried on the surface of the photosensitive drum 22 can contact the surface of the photosensitive drum 22 when the developing roller 16 rotates. That is, it may be said that the contact position is a developing position where the toner carried on the surface of the developing roller 16 can be transferred (deposited) onto the surface of the photosensitive drum 22 when the developing roller 16 rotates.

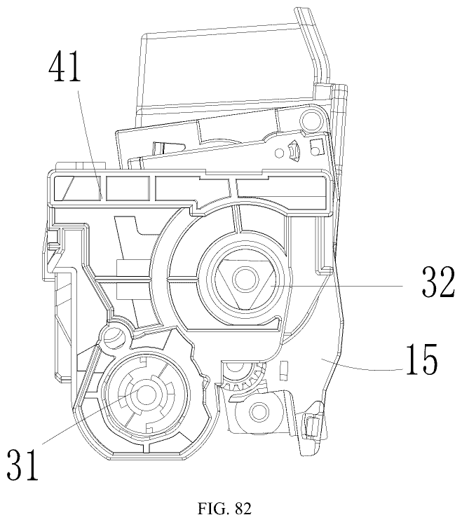

As shown in FIG. 82 to FIG. 85, when the driving force from the image-forming device stops rotating, the developing coupling 32 no longer receives the torque generated by the driving force to make the developing frame move relative to the photosensitive frame. Due to the elastic force of the separating elastic member 6 in the separating mechanism 60, the abutting member pushes the developing box cover 15, so that the lower end of the developing frame 11 tends to rotate around the rotation center away from the photosensitive frame 21, and the separating elastic member 6 is deformed, forcing the abutting member 62 to enter the bottom of the arc slot of the action part 154 again. At this moment, the abutting member 62 is exposed from the accommodating member 63 due to the elastic force of the separating elastic member 6. The elastic force of the separating elastic member 6 pushes the developing unit 10 to rotate around its swing axis K from the contact position to the separated position in the V1 direction (counterclockwise direction) until the developing roller 16 separates from the photosensitive drum 22.

In the disclosed embodiment, the processing cartridge 100, by means of a separating mechanism 60 disposed between the developing box cover and the driving side end cover and by means of the rotating torque of the developing drive unit, realizes the following: when the image-forming device is performing a developing operation, the photosensitive drum 22 maintains contact with the developing roller 16, and when the operation stops, the photosensitive drum 22 maintains separated from the developing roller 16. This solves the technical problems in the existing technology of long-term contact between the photosensitive drum 22 and the developing roller, which causes the deposition of colorant on the photosensitive drum 22 thereby contaminating the photosensitive drum 22, and of the long-term friction between the photosensitive drum 22 and the developing roller 16, which accelerates the deterioration of the developing roller or the developer.

Benefits of the present disclosure include: when the processing cartridge of the present disclosure receives a driving force through the developing coupling on the developing unit, the developing unit is moved to the contact position by utilizing the torque generated by rotation. When the driving force is removed, the developing unit is moved to the separated position due to the disappearance of the torque and the action of the separating mechanism. The structure is simple and easy to implement, the cost is low, the service life of the processing cartridge is extended, and the stability of the use of the processing cartridge is improved.

The embodiments described above are only some embodiments of the present disclosure. For persons skilled in the art, various modifications and improvements may be made without departing from the creative concept of the present disclosure, all of which shall fall within the scope of protection of the present disclosure.

What is claimed is:

1. A processing cartridge, comprising:
a photosensitive unit, including a photosensitive drum and a photosensitive frame;
a developing unit, including a developing roller and a developing frame, wherein the developing unit is capable of moving, relative to the photosensitive unit, between a position where the developing roller contacts the photosensitive drum and a position where the developing roller is separated from the photosensitive drum;
a developing coupling, for receiving a rotational driving force and being disposed at one end of a length direction of the processing cartridge; and
an elastic member, disposed between the developing unit and the photosensitive unit,
wherein, when the developing coupling does not receive the rotational driving force to rotate, under an action of an elastic force, the developing unit is maintained at a separated position, and the developing roller is kept separated from the photosensitive drum; and when the developing coupling receives the rotational driving force to rotate, a rotational torque exerts a force on the developing unit to move the developing unit from the separated position to a contact position, so that the developing roller contacts the photosensitive drum.

2. The processing cartridge according to claim 1, wherein, when the developing coupling does not receive the rotational driving force to rotate, the elastic force of the elastic member acts on the developing unit to make a lower end of the developing unit away from the photosensitive unit, so that the developing roller is kept separated from the photosensitive drum.

3. The processing cartridge according to claim 2, wherein, when the developing coupling receives the rotational driving force to rotate, the force exerted by the rotational torque on the developing unit is greater than the force of the elastic member on the developing unit, and the lower end of the developing unit moves toward a direction close to the photosensitive unit, so that the developing unit moves from the separated position to the contact position.

4. The processing cartridge according to claim 2, wherein the elastic member is a tension spring; and when the developing coupling does not receive the rotational driving force to rotate, a force of the tension spring acts on the developing unit so that the lower end of the developing unit has a tendency to rotate around a rotation center away from the photosensitive unit.

5. The processing cartridge according to claim 2, further comprising a driving side end cover and a developing box cover, wherein:
the driving side end cover is located at one end of the photosensitive frame, the developing box cover is located at one end of the developing frame, and the driving side end cover covers an outside of the developing box cover; and
the elastic member is located at one end of the length direction of the processing cartridge, one end of the elastic member is sleeved on the driving side end cover, and another end of the elastic member is sleeved on the developing box cover.

6. The processing cartridge according to claim 1, further comprising a developing roller gear and a photosensitive drum gear, wherein:
the developing roller gear is sleeved on one end of the developing roller, and the photosensitive drum gear is disposed at one end of the photosensitive drum; and
the developing coupling receives the rotational driving force and transmits the rotational driving force to the developing roller gear, and then the developing roller gear transmits the rotational driving force to the photosensitive drum gear to drive the photosensitive drum to rotate.

7. A processing cartridge, detachably mounted in an image forming device, and comprising:
a photosensitive unit, including a photosensitive drum and a photosensitive frame;
a developing unit, including a developing roller and a developing frame, wherein the developing unit is capable of moving, relative to the photosensitive unit, between a position where the developing roller contacts the photosensitive drum and a position where the developing roller is separated from the photosensitive drum;
a developing coupling, for receiving a rotational driving force and being disposed at one end of a length direction of the processing cartridge; and
an elastic member, disposed between the developing unit and the photosensitive unit,
wherein, when the processing cartridge stops developing in the image forming device, an elastic force of the elastic member keeps the developing unit in a separated position; and when the developing coupling receives the rotational driving force from the image forming device and starts to rotate, a rotational torque exerts a force on the developing unit to move the developing unit from the separated position to a contact position, so that the developing roller contacts the photosensitive drum.

8. The processing cartridge according to claim 7, wherein when the developing unit stops developing, the elastic force of the elastic member acts on the developing unit to move a lower end of the developing unit away from the photosensitive unit, so that the developing roller and the photosensitive drum remain separated; and when the developing coupling receives the rotational driving force from the image forming device and starts to rotate, the force exerted by the rotational torque on the developing unit is greater than the elastic force exerted by the elastic member on the developing unit, and the lower end of the developing unit moves toward the photosensitive unit, so that the developing unit moves from the separated position to the contact position.

9. A processing cartridge, comprising:
a photosensitive unit having a photosensitive drum;
a developing unit having a developing roller, wherein the developing unit is capable of moving, relative to the photosensitive unit, between a contact position where the developing roller contacts the photosensitive drum and a separated position where the developing roller separates from the photosensitive drum;
a developing coupling, for receiving a rotational driving force and being disposed at a driving end of the processing cartridge; and
an elastic member connected to the photosensitive unit and the developing unit,
wherein, when the developing coupling stops rotating, under an action of the elastic member, the developing unit is in the separated position, and the developing roller remains separated from the photosensitive drum; and when the developing coupling receives power to rotate, a rotational force generated by a rotation of the developing coupling is greater than an elastic force of the elastic member, so that the developing unit moves from the separated position to the contact position, and the developing roller moves toward the photosensitive drum, and
wherein, a delay mechanism is also included, and the delay mechanism delays the time for the developing unit to move from the separated position to the contact position, so that the developing roller delays a contact with the photosensitive drum.

10. The processing cartridge according to claim 9, wherein, when the developing coupling stops rotating, the developing unit moves from the contact position to the separated position without delay, and the developing roller is quickly separated from the photosensitive drum.

11. The processing cartridge according to claim 9, further comprising connecting teeth, wherein:
the connecting teeth are located at one end of the developing unit;
the delay mechanism has a delay gear; and
when the developing coupling receives the power to rotate, when the developing unit moves from the separated position to the contact position, the developing unit drives the connecting teeth to rotate and transmits the rotational force to the delay gear.

12. A processing cartridge, comprising:
a photosensitive unit, including a photosensitive drum and a photosensitive frame;
a developing unit, including a developing roller and a developing frame, wherein the developing unit is capable of moving, relative to the photosensitive unit, between a position where the developing roller contacts the photosensitive drum and a position where the developing roller separates from the photosensitive drum;
a developing coupling, for receiving a rotational driving force and being disposed at one end of a length direction of the processing cartridge;
an elastic member, connected to the developing unit and the photosensitive unit;
a transmission member, rotatably arranged at one end of the developing unit, the transmission member capable of being driven to rotate by the developing coupling; and
a rotating member, rotatably arranged at one end of the photosensitive unit, the rotating member capable of being driven to rotate by the transmission member,
wherein, in a process of a lower end of the developing unit moving toward a lower end of the photosensitive unit, when the transmission member driven to rotate by the developing coupling drives the rotating member to rotate, the developing roller and the photosensitive drum are not yet in contact; and when the rotating member is unable to be driven to rotate by the transmission member, the developing unit moves to a position where the developing roller contacts the photosensitive drum, so that the developing roller contacts the photosensitive drum.

13. The processing cartridge according to claim 12, wherein the transmission member drives the rotating member to rotate by meshing with a gear of the rotating member.

14. The processing cartridge according to claim 13, wherein a circumferential surface of the rotating member is provided with a gear portion, and the gear portion is provided with a section of teeth.

15. The processing cartridge according to claim 12, wherein the transmission member and/or a surface of the transmission member has friction, and the transmission member drives the rotating member to rotate by the friction.

16. The processing cartridge according to claim 12, further comprising a driving side bearing, wherein the driving side bearing is disposed at one end of a length direction of the developing unit, the transmission member is rotatably supported on the driving side bearing, and in a height direction of the processing cartridge, the transmission member is arranged close to the lower end of the developing unit.

16. The processing cartridge according to claim 12, further comprising a photosensitive coupling, wherein the photosensitive coupling is disposed at one end of a length direction of the photosensitive drum, and the rotating member is sleeved on the photosensitive coupling; and when the developing coupling does not drive the transmission member to rotate, and the transmission member does not drive the rotating member to rotate, the photosensitive coupling is capable of driving the rotating member to rotate under an action of a friction between the photosensitive coupling and the rotating member.

17. A processing cartridge, comprising:
a photosensitive unit, including a photosensitive drum and a photosensitive frame;
a developing unit, including a developing roller and a developing frame, wherein the developing unit is capable of moving, relative to the photosensitive unit, between a position where the developing roller contacts the photosensitive drum and a position where the developing roller separates from the photosensitive drum;
a developing coupling, for receiving a rotational driving force and being disposed at one end of a length direction of the processing cartridge;
an elastic member, connected to the developing unit and the photosensitive unit;
a transmission member, rotatably arranged at one end of the developing unit, the transmission member capable of being driven to rotate by the developing coupling; and
a rotating member, rotatably arranged at one end of the photosensitive unit, the rotating member capable of being driven to rotate by the transmitting member,
wherein, before the developing coupling receives the rotational driving force, under an action of an elastic force, the developing unit is maintained at a position where the developing roller is separated from the photosensitive drum, and the developing roller is kept separated from the photosensitive drum, and
wherein, when the developing coupling receives the rotational driving force to rotate, under an action of a driving force torque, a lower end of the developing unit moves toward a lower end of the photosensitive unit; when the developing coupling drives the transmission member to rotate, and the transmission member drives the rotating member to rotate, the developing roller and the photosensitive drum are not yet in contact; and when the rotating member is unable to be driven to rotate by the transmission member, the developing unit moves to a position where the developing roller contacts the photosensitive drum, so that the developing roller contacts the photosensitive drum.

18. The processing cartridge according to claim 17, wherein the transmission member drives the rotating member to rotate by meshing with a gear of the rotating member, and a circumferential surface of the rotating member is provided with a gear portion, and the gear portion is provided with a section of teeth.

19. The processing cartridge according to claim 17, wherein the transmission member and/or a surface of the transmission member has friction, and the transmission member drives the rotating member to rotate by the friction.

20. The processing cartridge according to claim 17, further comprising a photosensitive coupling, wherein the photosensitive coupling is disposed at one end of a length direction of the photosensitive drum, and the rotating member is sleeved on the photosensitive coupling; and when the developing coupling does not drive the transmission member to rotate, and the transmission member does not drive the rotating member to rotate, the photosensitive coupling is capable of driving the rotating member to rotate under an action of a friction between the photosensitive coupling and the rotating member.
